(19) United States
(12) Patent Application Publication
(10) Pub. No.: US 2011/0305787 A1
(43) Pub. Date: Dec. 15, 2011

(54) STAMPER FOR TRANSFER OF MICROSCOPIC STRUCTURE AND TRANSFER APPARATUS OF MICROSCOPIC STRUCTURE

(76) Inventors: Satoshi ISHII, Hitachi (JP); Masahiko Ogino, Hitachi (JP); Noritake Shizawa, Ninomiya (JP); Kyoichi Mori, Oiso (JP); Akihiro Miyauchi, Hitachi (JP); Naoaki Yamashita, Ninomiya (JP); Toshimitsu Shiraishi, Ninomiya (JP); Takashi Tarumitsu, Ninomiya (JP)

(21) Appl. No.: 13/157,403

(22) Filed: Jun. 10, 2011

(30) Foreign Application Priority Data
Jun. 11, 2010 (JP) 2010-133508

(51) Int. Cl. B29C 59/02

(52) U.S. Cl. 425/385

(57) ABSTRACT

A stamper is used for the transfer of microscopic structures, the stamper including a base and a microscopic structure layer on a surface thereof, in which the microscopic structure layer has a surface layer including a polymer derived from a resin composition containing a polymerization initiator and a silsesquioxane derivative having two or more polymerizable functional groups, the microscopic structure layer has a modulus of elasticity of less than 2.0 GPa and has a thickness of 4 times or more the height of a microscopic structure formed on the surface of the microscopic structure layer.

### CLAIM OF PRIORITY

The present application claims priority from Japanese Patent application serial No. 2010-133508, filed on Jun. 11, 2010, the content of which is hereby incorporated by reference into this application.

### TECHNICAL FIELD

The present invention relates to a stamper for the transfer of a microscopic structure, the stamper being pressed against a transfer target to form a microscopic structural body on a surface of the target; and to a transfer apparatus of the microscopic structure using the stamper.

### BACKGROUND ART

A photolithography technique has been frequently used as a technique for processing microscopic structures (microstructures) needed typically in semiconductor devices. However, with finer design rules of the microscopic structures as small as the wavelength of a light source used for the exposure, it becomes difficult to form such microscopic structures by the photolithography technique. For this reason, an electron beam lithography system, a kind of a charged particle beam apparatus, has been used instead of the photolithography technique.

Such a technique for forming the microscopic structure using the electron beams is a technique of directly drawing a mask pattern, unlike a method for forming the microscopic structure according to a full plate exposure method using a light source such as i-ray or excimer laser beams. Therefore, there is a disadvantage that an exposure time (drawing time) increases with an increasing number of the microscopic structures to be formed. Accordingly, it requires a long time to complete the formation of the microscopic structures. With an increasing degree of integration of a semiconductor integrated circuit, a time required for the formation of fine structure increases, which may result in a poor throughput.

To avoid the disadvantage and to speed up the formation using the electron beam lithography system, an electron beam cell projection lithography technique has been developed, in which electron beams are applied en bloc to a plurality of combined masks in various shapes to form a complex-shaped beam. However, with smaller and smaller design rules for microscopic structures, this technique suffers from many factors which raise the system cost, such as increase in size of the electron beam lithography system and increase in accuracy of mask alignment.

In contrast, a nanoimprinting technique attracts a considerable attention as a technique for accurately forming a microscopic structure at low cost. In this nanoimprinting technique, the microscopic structure can be formed on a resin layer of a transfer target by pressing a stamper against the transfer target, the stamper having a concavo-convex pattern (a surface configuration) corresponding to a convexo-concave pattern of the microscopic structure to be formed, and the transfer target being obtained typically by forming the resin layer on a predetermined substrate. It is examined to adopt the nanoimprinting technique to not only the formation of microscopic structures of recording bits in large-capacity recording media and the formation of microscopic structures in semiconductor integrated circuits, but also the formation of microscopic structures which allow light-emitting diodes (LEDs) to have higher brightness or which allow fuel cells and solar cells to have higher efficiency.

Hard or rigid stampers made typically of quartz, which have been used for the nanoimprinting technique, now suffer from a problem that there occurs a non-contact region (poor transfer region) in a wide region around the bumps and/or foreign particles where the stamper cannot be in contact with the transfer target when the transfer-target substrate warps or bears bumps/foreign particles. To reduce the poor transfer region, both warpage and bumps/foreign particles in the substrate should be absorbed. Patent Literature 1 has proposed a resin stamper which is made of a flexible resin material and conforms both warpage and bumps in the substrate. There has also been reported a multilayer resin stamper which includes a rigid base made typically of glass, a microscopic structure layer as a resin layer having a microscopic structure on its surface, and a flexible resin layer called a cushioning layer being arranged between the base and the microscopic structure layer.

In the nanoimprinting technique, the releasing (peeling) of the transfer target from the microscopic structure of the stamper significantly affects transfer accuracy, and the releasability between the two members becomes of very importance. The customary stampers made typically of quartz and used in nanoimprinting enable easy releasing the two members from each other by treating their surface with a fluorine release agent.

The nanoimprinting lithography technique is a technique in which a predetermined microscopic structure is previously formed on a master mold through an electron beam exposure technique or another fine patterning technique, and the resulting master mold is pressed against a transfer-target substrate having a resist layer coated thereon to thereby transfer the microscopic structure of the master mold to the resist layer on the transfer-target substrate under pressurization. This technique does not need a special expensive exposure system, as long as a master mold is provided, and enables commercial production of replicas of the master mold using an apparatus of regular printing machine level, and thereby shows a dramatically higher throughput and a significantly lower production cost than those of the electron beam exposure technique. An apparatus used for these purposes and including the stamper made of quartz or resin is called typically as a “transfer apparatus of a microscopic structure” or “imprinting apparatus”. Patent Literature 2 discloses a technique relating to an imprinting method and an imprinting apparatus for the method, the method including the steps of aligning, pressing, UV-irradiation, and releasing, and further includes the step of conveying a mold and a substrate in combination between adjacent units.

### PRIOR ART LITERATURES

### Patent Literatures

[Patent Literature 1] Japanese Unexamined Patent Publication No. 2010-5972
[Patent Literature 2] Japanese Unexamined Patent Publication No. 2009-265187

### SUMMARY OF THE INVENTION

### Problems to be Resolved by the Invention

Rigid stampers suffer from a problem that there occurs a non-contact region (poor transfer region) in which the stamper cannot be in contact with the transfer target in a wide region around the bumps and/or foreign particles when the transfer-target substrate warps or bears bumps/foreign particles. In addition, the customary stampers which has been subjected to a surface treatment with a release agent suffer from such problems that the resulting microscopic structure shows a low transfer accuracy due to uneven thickness of the release agent coated on the surface of the stamper, or the formation failure of the microscopic structures due typically to the deterioration of the release agent as a result of repeated transfer operations of the microscopic structures.

An object of the present invention is to provide a stamper for the transfer of a microscopic structure which is a resin stamper including a microscopic structure layer eliminating the need for a mold-release treatment, and giving the microscopic structure with satisfactory transfer accuracy without deterioration even after repeated transfer operations. Another object of the present invention is to provide a transfer apparatus of a microscopic structure (imprinting apparatus) equipped with the stamper. As used herein the term “microscopic structure” refers to a structure of a size on the order of from nanometers to micrometers.

### Means of Solving the Problems

A stamper for the transfer of a microscopic structure of the present invention includes a microscopic structure layer on a surface of a base, in which the microscopic structure layer has a surface layer including a polymer derived from a resin composition containing a silsesquioxane derivative.

### Advantageous Effect of the Invention

The present invention provides a stamper for the transfer of the microscopic structure and a transfer apparatus of the microscopic structure using the stamper, the stamper being a resinous stamper, including a microscopic structure layer which eliminates the need for a mold-release treatment to a resin as a transfer target and which does not suffer from deterioration in transfer accuracy of the microscopic structure even after repeated transfer operations because adsorptive power or adhesive strength between the resin coated on the transfer-target substrate and the microscopic structure layer becomes less and they are more easily releasable.

### BRIEF DESCRIPTION OF DRAWINGS

FIG. 1A is a side view schematically illustrating a step for the manufacture of a stamper for the transfer of a microscopic structure.

FIG. 1B is a side view schematically illustrating a step for the manufacture of the stamper for the transfer of the microscopic structure.

FIG. 1C is a side view schematically illustrating a step for the manufacture of the stamper for the transfer of the microscopic structure.

FIG. 1D is a side view schematically illustrating the configuration of a stamper for the transfer of the microscopic structure including neighboring members.

FIG. 2A is a side view illustrating a basic configuration of the stamper for the transfer of the microscopic structure.

FIG. 2B is a side view illustrating a modified embodiment of the stamper for the transfer of the microscopic structure.

FIG. 3A is a side view illustrating a configuration of a transfer target.

FIG. 3B is a side view illustrating a step of transferring the microscopic structure of the stamper to a transfer target.

FIG. 3C is a side view illustrating a step of transferring the microscopic structure of the stamper to the transfer target.

FIG. 3D is a side view illustrating a step of transferring the microscopic structure of the stamper to the transfer target.

FIG. 4 is a schematic configuration diagram illustrating a transfer apparatus of a microscopic structure as an embodiment.

FIG. 5 is a schematic configuration diagram illustrating a resin coating mechanism of the transfer apparatus.

FIG. 6 is a schematic configuration diagram illustrating an aligning mechanism of the transfer apparatus.

FIG. 7 is schematic configuration diagram illustrating the aligning mechanism of the transfer apparatus.

FIG. 8 is schematic configuration diagram illustrating the aligning mechanism of the transfer apparatus.

FIG. 9 is a schematic configuration diagram illustrating a pressurizing mechanism of the transfer apparatus.

FIG. 10 is a schematic configuration diagram illustrating a separating mechanism of the transfer apparatus.

FIG. 11 is a schematic configuration diagram illustrating the separating mechanism of the transfer apparatus.

FIG. 12 is a schematic configuration diagram illustrating the separating mechanism of the transfer apparatus.

FIG. 13 is a schematic configuration diagram illustrating the separating mechanism of the transfer apparatus.

FIG. 14 is a schematic configuration diagram illustrating the separating mechanism of the transfer apparatus.

FIG. 15 is a schematic configuration diagram illustrating an aligning mechanism of a transfer apparatus of a double-sided microscopic structure.

FIG. 16 is a schematic configuration diagram illustrating the aligning mechanism and a pressurizing mechanism of the transfer apparatus of the double-sided microscopic structure.

FIG. 17 is a schematic configuration diagram illustrating a separating mechanism of the transfer apparatus of the double-sided microscopic structure.

FIG. 18 is a schematic configuration diagram illustrating the separating mechanism of the transfer apparatus of the double-sided microscopic structure.

FIG. 19 is a schematic configuration diagram illustrating the separating mechanism of the transfer apparatus of the double-sided microscopic structure.

FIG. 20 is a schematic configuration diagram illustrating the separating mechanism of the transfer apparatus of the double-sided microscopic structure.

FIG. 21A is a side view illustrating an evaluation procedure of conformability.

FIG. 21B is a side view illustrating the evaluation procedure of conformability.

FIG. 21C is a side view illustrating the evaluation procedure of conformability.

FIG. 22 is a side view illustrating an evaluation procedure of releasability.

### MODE FOR CARRYING OUT THE INVENTION

A transfer apparatus of a microscopic structure, a transfer apparatus of a double-sided microscopic structure, and a stamper for the transfer of a microscopic structure will be illustrated below as embodiments of the present invention.

The transfer apparatus of a microscopic structure includes a stamper including a base and a microscopic structure layer formed on a surface of the base; and a pressurizing mechanism including an upper head and a lower stage between which a transfer-target substrate and the stamper are sandwiched and pressurized, the transfer-target substrate having a resin coating thereon, and the transfer apparatus cures the resin while pressing the microscopic structure layer against the resin and thereby forms a microscopic structural body of the resin on the surface of the transfer-target substrate, in which the microscopic structure layer has a surface layer including a polymer derived from a resin composition containing a silsesquioxane derivative.

The transfer apparatus preferably further includes a resin coating mechanism; a substrate-handling mechanism; an aligning mechanism; and a separating mechanism, in which the stamper is fixable to a bottom of the upper head, the lower stage and the separating mechanism are horizontally movable, the lower stage horizontally moves after being separated from the transfer-target substrate which is in intimate contact with the stamper, and the separating mechanism moves to a lower part of the transfer-target substrate in intimate contact with the stamper and peels off the transfer-target substrate from the stamper.

The transfer apparatus preferably further includes a guide rail; and a movement-driving mechanism, in which the lower stage and the separating mechanism are installed on the guide rail so as to be movable along the guide rail, and the movement-driving mechanism allows the lower stage and the separating mechanism to be movable alternately to such a position as to face the stamper with a center on a position of the stamper supported by the upper head.

In a preferred embodiment of the transfer apparatus, the microscopic structure layer has a modulus of elasticity of less than 2.0 GPa and has a thickness of 4 times or more the height of a microscopic structure formed on the surface of the microscopic structure layer.

In the transfer apparatus, the microscopic structure layer preferably has a modulus of elasticity of more than 0.3 GPa.

In another preferred embodiment of the transfer apparatus, the resin composition contains a polymerization initiator, and the polymerization initiator is a cationic-polymerization initiator which generates a cation by an action of an ultraviolet ray and thereby initiates curing.

In the transfer apparatus, the resin composition preferably contains a monomer component having at least two polymerizable functional groups.

In another preferred embodiment of the transfer apparatus, the resin composition contains two or more different monomer components, and at least one of the monomer components has a perfluoro skeleton.

A transfer apparatus of a double-sided microscopic structure includes an upper stamper and a lower stamper each including a base and a microscopic structure layer formed on a surface of the base; an elevating mechanism; a guide rail; a movement-driving mechanism; and a separating mechanism, the upper stamper being supported by the elevating mechanism so as to be vertically movable, the lower stamper being fixed to a movable table installed on the guide rail, the separating mechanism being arranged on the guide rail, the movable table and the separating mechanism being horizontally movable along the guide rail, the movement-driving mechanism allowing the lower stage and the separating mechanism to be movable alternately to such a position as to face the upper stamper with a center on a position of the upper stamper, and the transfer apparatus cures the resin while pressing the microscopic structure layers of the upper stamper and the lower stamper against the resin and thereby forms microscopic structural bodies of the resin on both sides of the transfer-target substrate, in which the microscopic structure layers each have a surface layer including a polymer derived from a resin composition containing a silsesquioxane derivative.

In the transfer apparatus, the microscopic structure layer preferably has a modulus of elasticity of less than 2.0 GPa and has a thickness of 4 times or more the height of a microscopic structure formed on the surface of the microscopic structure layer.

In the transfer apparatus, the microscopic structure layer preferably has a modulus of elasticity of more than 0.3 GPa.

In the transfer apparatus, the resin composition preferably contains a polymerization initiator, and the polymerization initiator is preferably a cationic-polymerization initiator which generates a cation by an action of an ultraviolet ray and thereby initiates curing.

In the transfer apparatus, the resin composition preferably contains a monomer component having at least two polymerizable functional groups.

The stamper for the transfer of a microscopic structure includes a base; and a microscopic structure layer formed on a surface of the base, in which the microscopic structure layer has a surface layer including a polymer which is derived from a resin composition containing a polymerization initiator and a silsesquioxane derivative having a plurality of polymerizable functional groups, and the microscopic structure layer has a modulus of elasticity of less than 2.0 GPa and has a thickness of 4 times or more the height of a microscopic structure formed on a surface of the microscopic structure layer.

In the stamper, the microscopic structure layer preferably has a modulus of elasticity of more than 0.3 GPa.

In the stamper, the polymerization initiator is preferably a cationic-polymerization initiator which generates a cation by an action of an ultraviolet ray and thereby initiates curing.

In the stamper, the resin composition preferably contains a monomer component having at least two polymerizable functional groups.

In a preferred embodiment of the stamper, the resin composition contains two or more different monomer components, at least one of the two or more monomer components has a perfluoro skeleton, and at least one of the two or more monomer components has at least two polymerizable functional groups.

In the stamper, one of the monomer components is preferably 1,4-bis(2,3-epoxypropyl)perfluorobutane.

The stamper preferably further includes an optically transparent elastic plate and an optically transparent rigid substrate on an opposite surface to a surface having the microscopic structure layer of the base.

The present invention will be illustrated in detail with reference to the attached drawings as appropriate.

(Manufacturing Method of Stamper for Transfer of Microscopic Structure)

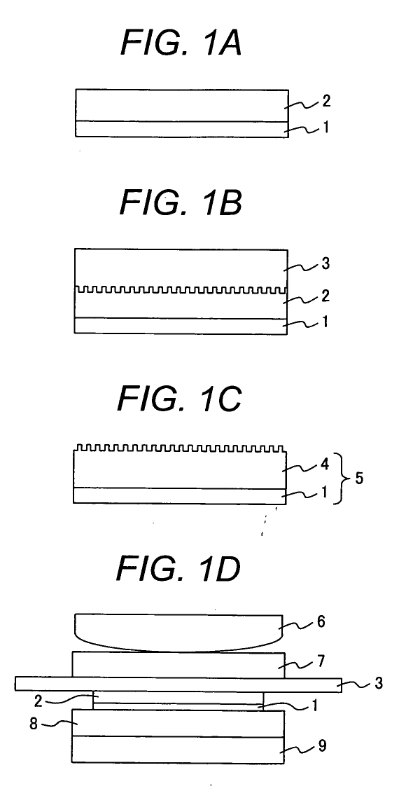

A method for manufacturing the stamper for the transfer of a microscopic structure according to the embodiment will be illustrated below, with reference to FIGS. 1A, 1B and 1C. These figures are side views schematically illustrating steps of a manufacturing method of a stamper for a transfer of a microscopic structure.

According to the manufacturing method, a base material 1 (i.e., a base) is prepared, and a resin composition 2 is applied to a surface of the base material 1 (FIG. 1A).

Next, with reference to FIG. 1B, a master mold 3 bearing a microscopic structure on its surface is pressed against the surface of the resin composition 2 applied to the surface of the base material 1. An ultraviolet ray is applied to cure the resin composition 2 while pressing the master mold 3 thereagainst, and thereby the microscopic structure of the master mold 3 is transferred to the resin composition 2. The pressure (transfer pressure) to press the master mold 3 during the curing of the resin composition 2 is not limited. However, the transfer pressure upon the manufacture of the stamper for the transfer of a microscopic structure is preferably from about 0.01 to about 10 MPa. This range is preferred because the resin composition may be satisfactorily charged into the microscopic structure of the master mold 3, and the resin composition layer after imprinting may have a suitable thickness. In contrast to this process, the stamper 5 may be prepared by applying the resin composition 2 to the master mold 3, and pressing the base material 1 thereagainst from above.

With reference to FIG. 1D, the pressurization for the transfer of the microscopic structure is preferably performed while bringing an upper cushioning layer 7 and a lower cushioning layer 8 into intimate contact with a surface of the master mold 3 and with a surface of the base material 1, respectively, both surfaces being opposite to the resin composition 2, in which the upper cushioning layer 7 and lower cushioning layer 8 are made of an elastic substance such as a silicone rubber. In other words, the master mold 3 and the base material 1 coated with the resin composition 2 are placed between the upper cushioning layer 7 and the lower cushioning layer 8. The presence of the upper cushioning layer 7 and the lower cushioning layer 8 uniformizes the pressure. To avoid the inclusion of gas bubbles in the coated resin composition 2, the pressure is preferably applied in a direction from the central part to the outer periphery of the resin composition 2. Specifically, pressurization is more preferably performed from the backside of the upper cushioning layer 7 with an upper plate 6 (convex glass) having a spherical (convex) pressurizing surface. In this procedure, a flat lower plate 9 (e.g., glass) is preferably arranged on the backside of the lower cushioning layer 8. It is also accepted that the lower plate 9 is designed to have a spherical (convex) surface, whereas the upper plate 6 is designed to be flat.

Next, with reference to FIG. 1C, the master mold 3 is peeled from the cured resin composition 2 (FIG. 1B) to give a stamper 5 for the transfer of a microscopic structure (hereinafter also simply referred to as “stamper 5”) according to the present embodiment, which stamper includes the base material 1 and a microscopic structure layer 4 formed on a surface of the base material 1. Exemplary peeling processes include a process of peeling after grasping an edge of the stamper 5; and a process of peeling while fixing the backsides of the master mold 3 and the base material 1 typically through vacuum chucking. The peeling typically through vacuum chucking is more preferred from the viewpoint typically of prevention of the surface of the microscopic structure from contamination.

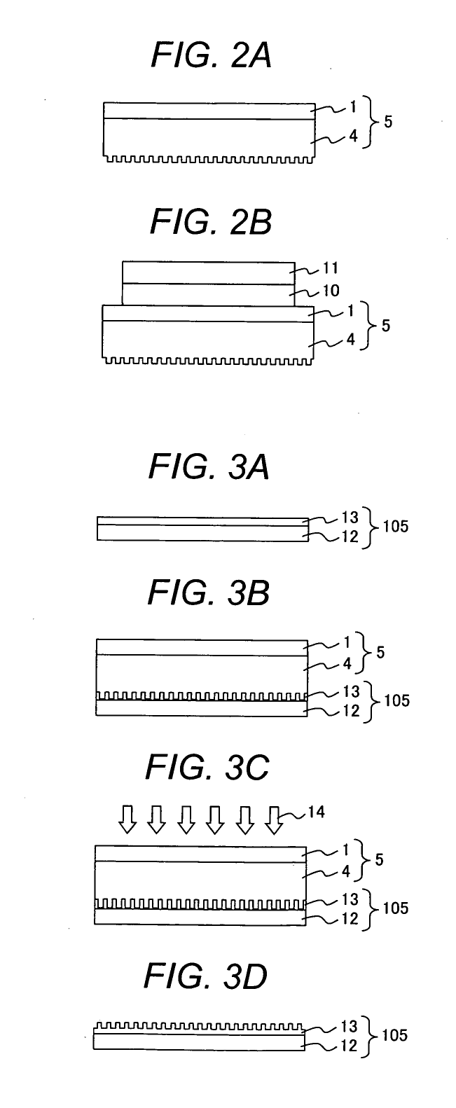

FIGS. 2A and 2B are schematic views of the stamper 5 prepared according to the present invention. FIG. 2A depicts the basic configuration of the stamper 5 according to the present invention; whereas FIG. 2B depicts the configuration of another stamper for the transfer of a microscopic structure. This stamper further includes an elastic plate 10 and an optically transparent rigid substrate 11 present on a side of the base material 1 opposite to the microscopic structure layer 4 which is in intimate contact with each other. The stamper according to this modified embodiment may achieve further satisfactory transfer properties. The elastic plate 10 and the optically transparent rigid substrate 11 illustrated in FIG. 2B are not necessarily integrated with the stamper 5. For example, it is accepted that the elastic plate 10 and the optically transparent rigid substrate 11 are fixed to the surface of a pressurizing stage of the transfer apparatus, whereas the stamper 5 is arranged on the surface of the elastic plate 10.

(Base Material of Stamper for Transfer of Microscopic Structure)

The base material 1 is not limited in its material, size, shape, and preparation process, as long as having the function of holding the microscopic structure layer 4. The base material 1 may have, for example, a circular, square, or rectangular shape. Particularly when used for both-sided transfer, the base material 1 preferably has a rectangular shape. A material for the base material 1 may be one having certain strength and workability, and examples thereof include silicon wafers, metal materials, glass, quartz, ceramics, and resin materials. Specific examples of the material include Si, SiC, SiN, polycrystalline Si (polysilicon), Ni, Cr, Cu, and materials each containing one or more of them. Among them, materials which are transparent at least to light at a wavelength of 365 nm are preferred, of which quartz and glass are more preferred for their high transparency. When the base material 1 is formed from such a highly transparent material, and when the microscopic structure layer 4 is composed of a photocurable resin as mentioned later, the photocurable resin can be efficiently irradiated with light. When the base material 1 is formed from such a highly transparent material, and when a cushioning layer (not shown) composed of a photocurable resin is provided between the base material 1 and the microscopic structure layer 4, the photocurable resin to constitute the cushioning layer can be efficiently irradiated with light.

A coupling treatment may be applied to the surface of the base material 1 to increase the bond strength with the microscopic structure layer 4 or with the cushioning layer (not shown).

The base preferably has a modulus of elasticity of 10 GPa or more for a maintained predetermined strength. The base more preferably has a modulus of elasticity of 50 GPa or more from the viewpoints of the durability and transfer accuracy of the stamper.

The base material 1 may also be composed of two or more layers having different moduli of elasticity. The base material 1 having this configuration is not limited in order of lamination between a layer having a higher modulus of elasticity and a layer having a lower modulus of elasticity, their combination, and number of layers.

Examples of the base material 1 having two or more different layers include a base having two or more layers respectively formed from two or more materials selected from the above-mentioned materials; a base having a layer composed of the material and another layer composed of a resin material in combination; and a base having a layer composed of a resin material and a layer composed of another resin material in combination.

Specific examples of the resin material include phenolic resins (phenol-formaldehyde resins; PFs), urea resins (urea-formaldehyde resins; UFs), melamine resins (melamine-formaldehyde resins; MFs), poly(ethylene terephthalate)s (PETs), unsaturated polyesters (UPs), alkyd resins, vinyl ester resins, epoxy resins (EPs), polyimides (PIs), polyurethanes (PURs), polycarbonates (PCs), polystyrenes (PSs), acrylic resins (e.g., poly(methyl methacrylate)s; PMMAs), polyamides (PAs), acrylonitrile-butadiene-styrene (ABS) resins, acrylonitrile-styrene (AS) resins, acrylonitrile-acrylate-styrene (AAS) resins, poly(vinyl alcohol)s, polyethylenes (PEs), polypropylenes (PPs), polytetrafluoroethylenes (PTFEs), polyarylates, cellulose acetate, polypropylenes (PPs), poly(ethylene naphthalate)s (PENs), poly(butylene terephthalate)s (PBTs), poly(phenylene sulfide)s (PPSs), poly(phenylene oxide)s, cycloolefin polymers, poly(lactic acid)s, silicone resins, and diallyl phthalate resins. Each of different resins may be used alone or in combination. The base may further contain one or more fillers such as inorganic fillers and organic fillers.

The microscopic structure layer 4 is a layer formed on a surface of the base material 1 and has a microscopic structure of a size on the order of from nanometers to micrometers on its surface. The microscopic structure layer 4 is composed of a polymer derived from a photocurable resin composition mentioned later.

The microscopic structure layer 4 may have a single-layer structure or a multilayer structure including two or more different layers having different moduli of elasticity. When the microscopic structure layer 4 has a multilayer structure, at least a layer having the microscopic structure is composed of a polymer derived from the after-mentioned photocurable resin composition. In a preferred embodiment, the layer bearing the microscopic structure has a higher modulus of elasticity, whereas a layer having a lower modulus of elasticity is provided below the layer bearing the microscopic structure.

(Master Mold)

The master mold 3 is not limited in its material, shape, thickness, and other factors, as long as having a microscopic structure on a surface thereof. The material for the master mold 3 may be one having certain strength and workability, and examples thereof include silicon wafers, metal materials, glass, quartz, ceramics, and resin materials. Specific examples of the material include Si, SiC, SiN, polycrystalline Si, Ni, Cr, Cu, and materials each containing one or more of them. When a transfer-target substrate (the base material 1 in this case) is composed of a material which is not transparent to an ultraviolet ray, the master mold 3 should be transparent to the ultraviolet ray and should thereby be composed of quartz or another material that is transparent to the ultraviolet ray.

(Ultraviolet Irradiation Device and Ultraviolet Source)

An ultraviolet irradiation device for use in the manufacture of the stamper 5 according to the present invention is not limited in type of light source, device configuration, and irradiation intensity, as long as being an ultraviolet irradiation device equipped with a light source which emits an ultraviolet ray capable of curing the resin composition. The irradiation device is preferably one which can apply at least an ultraviolet ray having a wavelength of 365 nm at an irradiation intensity of 50 to 200 mW/cm² in consideration of the throughput and cost of the nanoimprinting step. Exemplary ultraviolet sources include ultrahigh-pressure mercury lamps and light emitting diodes (LEDs).

(Resin Coating Process)

In the embodiment mentioned above, the resin composition 2 is applied to a surface of the base material 1, and thereafter the master mold 3 is brought into intimate contact with the resin composition 2. However, the preparation process of the stamper for use in the present invention is not limited to this procedure, and it is also acceptable that the resin composition 2 is applied to the master mold 3, and thereafter the base material 1 is brought into intimate contact with the applied resin composition.

Exemplary coating procedures for coating the resin composition 2 to the surface of the master mold 3 or the base material 1 include, but are not limited to, spin coating, dispensing, spray coating, and ink-jet coating. The dispensing is preferred in points that the amount of the resin composition 2 to be dropped or dispensed can be easily regulated, and thereby the thickness of the resulting microscopic structure layer 4 can be easily controlled.

(Resin Composition for Stamper for Transfer of Microscopic Structure)

The resin composition 2 for constituting the microscopic structure layer 4 mainly includes a silsesquioxane derivative and a photopolymerization initiator (photoinitiator). Of silsesquioxane derivatives, a silsesquioxane derivative having two or more polymerizable functional groups is particularly preferably employed so as to impart mechanical strength to the stamper 5 and to improve the durability of the stamper. The resin composition may further contain one or more components for constituting the resin composition 2, in addition to the silsesquioxane derivative component. Among such additional components, preferred are monomer components each having a short molecular chain, and fluorine monomer components each having a perfluoro skeleton, because these components effectively work for improved mechanical strength and improved releasability of the microscopic structure layer 4. Specifically, the resin composition 2 containing a silsesquioxane derivative shows a small adsorptive power or adhesive strength with respect to the resin (transfer target) coated on the transfer-target substrate and thereby is more peelable (releasable) from the resin. This eliminates the need for a mold-release treatment with respect to the resin as a transfer target.

<Silsesquioxane Derivative>

As used herein “silsesquioxane derivative” is a generic name of network polysiloxanes represented by the compositional formula of RSiO_{1.5}. The silsesquioxane derivative is known to be structurally positioned between an inorganic silica (compositional formula: SiO₂) and an organic silicone (compositional formula: R₂SiO) and to have characteristic properties between them.

Examples of such silsesquioxane derivatives include silsesquioxane derivatives represented by following Formulae (1) to (5). In this connection, following Formula (1) represents a silsesquioxane derivative of a ladder structure; Formula (2) represents a silsesquioxane derivative of a random structure; Formula (3) represents a silsesquioxane derivative of a T8 structure; Formula (4) represents a silsesquioxane derivative of a T10 structure; and Formula (5) represents a silsesquioxane derivative of a T12 structure. Among them, silsesquioxane derivatives each containing a dimethylsiloxane skeleton are preferred from the viewpoint of satisfactory releasability.

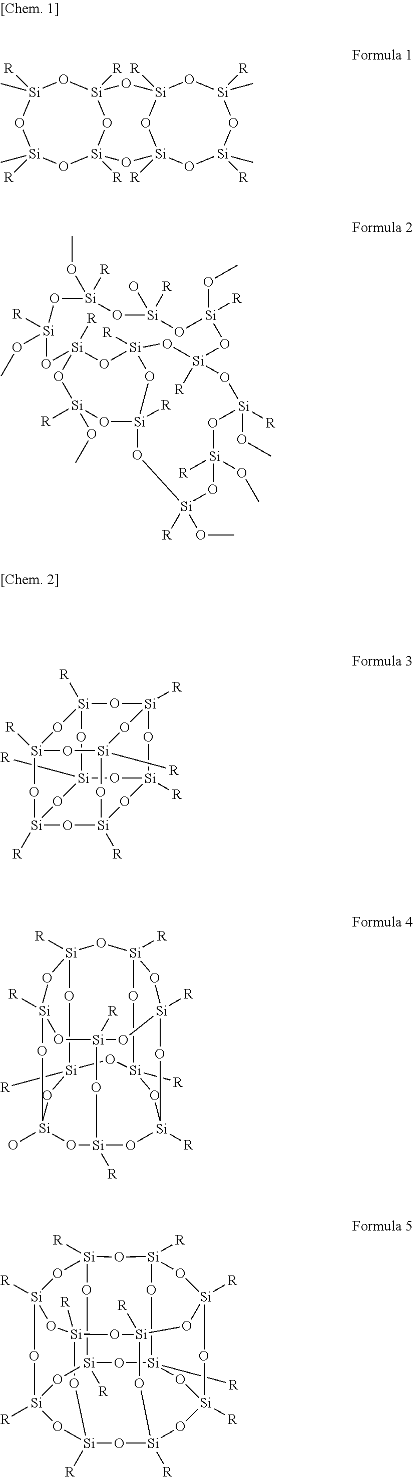

In Formulae (1) to (5), Rs may be the same as or different from one another and each represent a hydrogen atom or an organic group, wherein the organic group represents two or more, preferably three or more, of a polymerizable functional group mentioned later.

The polymerizable functional group is preferably at least one selected from the group consisting of vinyl group, epoxy group, oxetanyl group, vinyl ether group, and (meth)acrylic group. Exemplary possible polymerization mechanisms include photo-initiated radical polymerization, photo-initiated cationic polymerization, photo-initiated anionic polymerization, heat-initiated radical polymerization, and heat-initiated cationic polymerization.

The polymerizable functional groups of the silsesquioxane derivative preferably have a polymerization mechanism different from the polymerization mechanism of a curable resin material used in the after-mentioned transfer method using the stamper 5 according to the present invention. For example, when the curable resin material used in the transfer is a radically polymerizable one, the silsesquioxane derivative is preferably a cationically polymerizable or anionically polymerizable silsesquioxane derivative. When the curable resin material used in the transfer is a cationically polymerizable one, the silsesquioxane derivative is preferably a radically polymerizable or anionically polymerizable silsesquioxane derivative.

The silsesquioxane derivative may be a commercial product.

The resin composition preferably contains one or more silsesquioxane derivatives in a content of 50 percent by mass or more. Particularly in consideration of releasability and durability, the resin composition more preferably contains silsesquioxane derivative (s) in a content of 70 percent by mass or more.

<Monomer Components>

Exemplary monomer components to be added in order to improve properties of a cured article derived from the silsesquioxane derivative include multifunctional monomer components each having, per molecule, two or more polymerizable functional groups selected from the group consisting of vinyl group, (meth)acrylic group, epoxy group, oxetanyl group, and vinyl ether group. Such additional monomer components are not limited in their skeleton and other factors, but are preferably monomer components which are curable through the same mechanism as that of the polymerizable functional groups of the silsesquioxane derivative.

Exemplary monomer components having one or more epoxy groups include bisphenol-A epoxy resin monomers, hydrogenated bisphenol-A epoxy resin monomers, bisphenol-F epoxy resin monomers, novolak epoxy resin monomers, alicyclic epoxy resin monomers, aliphatic linear epoxy resin monomers, naphthalene epoxy resin monomers, biphenyl epoxy resin monomers, bifunctional alcohol ether epoxy resin monomers, and epoxy monomers each having a perfluoro chain.

Exemplary monomer components having one or more oxetanyl groups include
3-ethyl-3-{[3-ethyloxetan-3-yl]methoxymethyl}oxetane,
3-ethyl-3-hydroxymethyl oxetane,
1,4-bis[(3-ethyl-3-oxetanylmethoxy)methyl]benzene,
3-ethyl-3-(phenoxymethyl)-oxetane,
di[1-ethyl(3-oxetanyl)]methyl ether,
3-ethyl-3-(2-ethylhexyloxymethyl)-oxetane,
3-ethyl-3-{[3-(triethoxysilyl)propoxy]methyl}-oxetane,
oxetanylsilsesquioxane, phenolnovolakoxetane, and oxetanyl monomers each having a perfluoro chain.

Exemplary monomer components having one or more vinyl ether groups include ethylene glycol divinyl ether, diethylene glycol divinyl ether, triethylene glycol divinyl ether, tetraethylene glycol divinyl ether, butanediol divinyl ether, hexanediol divinyl ether, cyclohexanedimethanol divinyl ether, di(4-vinyloxy)butyl isophthalate, di(4-vinyloxy)butyl glutarate, di(4-vinyloxy)butyl succinate, trimethylolpropane trivinyl ether, 2-hydroxyethyl vinyl ether, hydroxybutyl vinyl ether, hydroxyhexyl vinyl ether, and divinyl ether monomers each having a perfluoro chain.

The above description has been made while taking, as an example, organic components each having one or more functional groups selected from the group consisting of epoxy group, oxetanyl group, and vinyl ether group, but the present invention is not limited thereto. Any of monomer components may be fundamentally used in the present invention, as long as having one or more polymerizable functional groups such as vinyl group, (meth)acrylic group, epoxy group, oxetanyl group, and vinyl ether group in molecular chain. It is basically assumed that liquid monomer components are employed in the present embodiment, but solid monomer components are also usable herein.

Each of different monomer components may be used alone or in combination herein.

<Photopolymerization Initiator>

The photopolymerization initiator for use herein may be appropriately chosen according to types of polymerizable functional groups of the silsesquioxane derivative and of monomer components both contained in the resin composition. Among them, cationic-polymerization initiators are preferred for the prevention of curing failure due to oxygen inhibition.

Such cationic-polymerization initiators are not limited, as long as each being an electrophilic reagent and having a cation source, and may be any known cationic-polymerization initiators. Among them, cationic-polymerization initiators which initiate a polymerization reaction by the action of an ultraviolet ray are preferred, because they enable the formation of a concavo-convex structure at room temperature and thereby enable the formation of replicas from the master mold with further higher accuracy.

Exemplary cationic-polymerization initiators include iron-allene complex compounds, aromatic diazonium salts, aromatic iodonium salts, aromatic sulfonium salts, pyridinium salts, aluminum complex/silyl ether, as wells as protonic acids, and Lewis acids.

Specific examples of cationic-polymerization initiators which initiate curing by the action of an ultraviolet ray include IRGACURE 261 (supplied by Ciba Geigy Ltd.), ADEKA OPTOMER SP150 (supplied by ADEKA CORPORATION), ADEKA OPTOMER SP151 (supplied by ADEKA CORPORATION), ADEKA OPTOMER SP152 (supplied by ADEKA CORPORATION), ADEKA OPTOMER SP-170 (supplied by ADEKA CORPORATION), ADEKA OPTOMER SP171 (supplied by ADEKA CORPORATION), ADEKA OPTOMER SP-172 (supplied by ADEKA CORPORATION), ADEKA OPTOMER SP300 (supplied by ADEKA CORPORATION), UVE-1014 (supplied by General Electric Company), CD-1012 (supplied by Sartomer Company Inc.), San-Aid SI-60L (supplied by Sanshin Chemical Industry Co., Ltd.), San-Aid SI-80L (supplied by Sanshin Chemical Industry Co., Ltd.), San-Aid SI-100L (supplied by Sanshin Chemical Industry Co., Ltd.), San-Aid SI-110 (supplied by Sanshin Chemical Industry Co., Ltd.), San-Aid SI-180 (supplied by Sanshin Chemical Industry Co., Ltd.), CI-2064 (supplied by Nippon Soda Co., Ltd.), CI-2639 (supplied by Nippon Soda Co., Ltd.), CI-2624 (supplied by Nippon Soda Co., Ltd.), CI-2481 (supplied by Nippon Soda Co., Ltd.), Uvacure 1590 (supplied by Daicel UCB (now DAICEL-CYTEC Company Ltd.)), Uvacure 1591 (supplied by Daicel UCB (now DAICEL-CYTEC Company Ltd.)), RHODORSIL Photo Initiator 2074 (supplied by Rhône-Poulenc (now Rhodia)), UVI-6990 (supplied by Union Carbide Corporation (now subsidiary of The Dow Chemical Company)), BBI-103 (supplied by Midori Kagaku Co., Ltd.), MPI-103 (supplied by Midori Kagaku Co., Ltd.), TPS-103 (supplied by Midori Kagaku Co., Ltd.), MDS-103 (supplied by Midori Kagaku Co., Ltd.), DTS-103 (supplied by Midori Kagaku Co., Ltd.), DTS-103 (supplied by Midori Kagaku Co., Ltd.), NAT-103 (supplied by Midori Kagaku Co., Ltd.), NDS-103 (supplied by Midori Kagaku Co., Ltd.), and CYRAURE UV 16990 (supplied by Union Carbide Japan K.K.). Each of different polymerization initiators may be used alone or in combination. In addition, such polymerization initiator(s) may be used in combination with known components such as polymerization promoters and sensitizers.

<Thickness of Microscopic Structure Layer>

The thickness of the microscopic structure layer 4 should be preferably a suitable thickness to exhibit a sufficient cushioning action so as to conform the warpage of the transfer-target substrate and the bumps and foreign particles present at the surface of the transfer-target substrate and to minimize a non-contact region. From this viewpoint, the microscopic structure layer 4 in the stamper 5 preferably has a thickness of 2 times or more the height of foreign particles. In more specific consideration about products to which the nanoimprinting technique is adopted and in consideration of sizes of the bumps and foreign particles, the microscopic structure layer preferably has a thickness of 4 times or more and more preferably 40 times or more the height of the microscopic structure. As used herein the term “height of the microscopic structure” refers to the height of a convex portion or the depth of a concave portion in the concavo-convex pattern constituting the microscopic structure.

When a hard disk drive (HDD) is taken as an example of products to which the nanoimprinting technique is adopted, foreign particles may have a size of about 100 nm in diameter, and the microscopic structure may have a height of 50 nm or less. In this case, the microscopic structure layer 4 preferably has a thickness of 200 nm or more. In the case of processing of a substrate for LED use, foreign particles may have a size of about 10 μm in diameter, and the microscopic structure may have a height of about 200 nm. In this case, the microscopic structure layer preferably has a thickness of 20 μm or more. In the case of semiconductor/integrated circuit, foreign particles may have a size of about 1 μm in diameter, and the microscopic structure may have a height of 50 nm or less. In this case, the microscopic structure layer 4 preferably has a thickness of 2 μm or more, and more preferably has a thickness of 40 times or more the height of the microscopic structure to exhibit conformability sufficiently. Even when adopted to other products, the microscopic structure layer 4 preferably has a thickness of at least 4 times or more the height of the microscopic structure.

In addition to having such a preferred thickness, the microscopic structure layer 4 preferably has a modulus of elasticity of less than 2.0 GPa, to exhibit such a sufficient cushioning action as to conform or follow the warpage of the transfer-target substrate and the bumps and foreign particles present at the surface of the transfer-target substrate and as to minimize a non-contact region. In contrast, the microscopic structure layer 4 preferably has a modulus of elasticity of 0.4 GPa or more from the viewpoint of improving the durability of the stamper, i.e., of protecting the microscopic structure from deformation and breakage. The microscopic structure layer 4 more preferably has a modulus of elasticity of 1.0 GPa or more for higher transfer accuracy.

The microscopic structure layer 4 herein may be designed to have a multilayer structure including two or more different layers having different moduli of elasticity, in which one layer assumes a role of durability, and another layer assumes a role of conformability. Specifically, the microscopic structure layer 4 may be composed of a layer bearing a microscopic structure and having a modulus of elasticity of 0.4 GPa or more, preferably 1.0 GPa or more, so as to ensure satisfactory durability; and underlying this layer, a layer having a low modulus of elasticity so as to have a cushioning action with respect to bumps and foreign particles. In this case, the latter layer having a low modulus of elasticity may have a modulus of elasticity of less than 0.4 GPa. The cushioning layer which is a resin layer having a low modulus of elasticity and exhibiting a cushioning action may have a single-layer structure or multilayer structure.

As used herein the term “modulus of elasticity” refers to a physical property indicating difficulty in (resistance to) deformation and means a constant of proportion between the stress and strain within the range of elastic change. In this connection, the modulus of elasticity varies depending on the temperature and is thereby not a unique value with respect to the material composition. In the present embodiment, however, the modulus of elasticity is defined as a value at 30° C. which temperature falls within conditions for a photo-nanoimprinting process.

In the resin composition 2, all the components other than the photo-induced polymerization initiator are a resin or resins having one or more polymerizable functional groups.

However, it is accepted that the resin composition further contains a solvent component having no reactive functional group, because such solvent component does not adversely affect the advantageous effects of the present invention. Independently, the resin composition 2 may further contain one or more surfactants for higher adhesion between the base material 1 and the resin composition 2, within ranges not adversely affecting the objects of the present invention. The resin composition may also further contain additives such as polymerization inhibitors according to necessity.

The photocurable resin composition 2 preferably has a functional group equivalent of 180 g/eq or more. The resin composition 2 more preferably has a functional group equivalent of 150 g/eq for further satisfactory mechanical strength of the microscopic structure layer 4, and furthermore preferably has a functional group equivalent of 130 g/eq for further higher hardness of the cured article and further higher transfer accuracy.

The functional group equivalent of the resin composition 2 is expressed by following Formulae (6) and (7):

Functional group equivalent of a component in resin composition 2=(Molecular weight of the component)/(Number of functional groups per molecule of the component) Formula (6)

Functional group equivalent of resin composition 2=(Average of the functional group equivalents of the respective components) Formula (7)

The resin composition preferably has a percentage of curing shrinkage of 8.0% or less, for more satisfactory dimensional accuracy of the microscopic structure in the formation of the microscopic structure layer.

The percentage of curing shrinkage (%) is expressed by following Formula (8):

Percentage of curing shrinkage=100×[(Specific gravity of polymer derived from resin composition)−(Specific gravity of resin composition before curing)]/(Specific gravity of resin composition before curing) Formula (8)

The inorganic fraction of the polymer derived from the resin composition, i.e., the inorganic fraction of the microscopic structure layer is 31 percent by mass or less, so as to allow the microscopic structure layer 4 to have a further higher modulus of elasticity to thereby enable highly accurate transfer of the microscopic structure with high durability.

The inorganic fraction is a content of an inorganic component SiO_{1.5} in the resin composition and is expressed by following Formula (9):

Inorganic fraction=100×(Sum of amounts of silicon and oxygen atoms in SiO_{1.5} in resin composition)/(Average molecular weight of the resin composition) Formula (9)

In the stamper 5 as mentioned above, the base material 1 and the microscopic structure layer 4 are preferably formed so as to be optically transparent (transparent with respect to at least light of a wavelength of 365 nm). The stamper 5 having this configuration allows the use of a photocurable resin as a curable resin material serving as the transfer target mentioned later. In other words, this stamper 5 is usable as a replica mold for photo-nanoimprinting.

Significant points of the stamper for the transfer of a microscopic structure according to the present invention are as follows.

In an embodiment, the microscopic structure layer provided on the surface of the base has a modulus of elasticity of less than 2.0 GPa and a thickness of 4 times or more, preferably 40 times or more, the height of the microscopic structure. This configuration allows the stamper to conform the warpage of the transfer-target substrate and to conform bumps and foreign particles present at the surface of the transfer-target substrate. In another embodiment, at least a layer bearing the microscopic structure is composed of, as a material, a polymer containing a silsesquioxane derivative as a principal component. This eliminates the need for a mold-release treatment to be applied to the stamper. In yet another embodiment, at least the layer bearing the microscopic structure has a modulus of elasticity of 0.4 GPa or more, and preferably 1.0 GPa or more. This ensures the durability of the microscopic structure layer. The microscopic structure layer herein may have a single-layer structure or multilayer structure.

(Transfer Method of Microscopic Structure to Photocurable Resin Using Stamper for Transfer of Microscopic Structure)

Next, a method for the transfer of a microscopic structure using the stamper 5 will be described below.

FIGS. 3A, 3B, 3C and 3D are schematic views illustrating steps for transferring the microscopic structure of the stamper 5 to a transfer target.

With reference to FIG. 3A, this transfer method employs a transfer target 105 which includes a transfer-target substrate 12 and, provided on a surface thereof, a curable resin material 13.

The transfer-target substrate 12 is not limited and may be suitably provided according to the intended use of the resulting microscopic structure obtained by transfer of the microscopic structure on the stamper. Exemplary materials for the transfer-target substrate 12 include materials having suitable strength and workability, such as silicon wafers, metal materials, glass, quartz, ceramics, and resin materials. The transfer-target substrate 12 may have a multilayer structure by forming a customary thin film such as a metal layer, resin layer, or oxide film layer according to necessity. Although not critical in its shape, the transfer-target substrate 12 preferably has a circular plate shape when a liquid resin is to be applied thereon by spin coating. In addition, a circular substrate having a concentric hole at the center is also included in substrates for use in the present invention.

As the curable resin material 13, those composed of two or more reactive components and having a low viscosity at room temperature are basically usable in the present invention. Of such materials, photocurable materials are preferred for shorter curing time. For example, a synthetic resin material added with a photo-sensitive material may be used. Exemplary principal components usable for the synthetic resin material include cycloolefin polymers, poly(methyl methacrylate)s (PMMAs), polystyrenes, polycarbonates, poly(ethylene terephthalate)s (PETs), poly(lactic acid)s (PLAs), polypropylenes, polyethylenes, and poly(vinyl alcohol)s (PVAs). Exemplary photo-sensitive materials for use in combination with such principal components include peroxides, azo compounds (e.g., azobisisobutyronitrile), ketones (e.g., benzoin and acetone), diaminobenzene, metal complex salts, and dyestuffs. A thin film of liquid resin formed through coating of the curable resin material 13 is also called a “resist film”.

As is described above, when the curable resin material 13 employs at least one of a photocurable resin and a heat-curable resin, the photocurable resin or heat-curable (thermosetting) resin is preferably one having a curing mechanism different from that of the silsesquioxane derivative contained as a principal component in the resin composition.

According to the transfer method, the stamper 5 is pressed against the curable resin material 13 of the transfer target 105, and whereby the microscopic structure is transferred to the curable resin material 13 to form a microscopic structure thereon. By designing the base material 1 and the microscopic structure layer 4 in the stamper 5 to be transparent with respect to light having a wavelength of 365 nm or more, a photocurable resin is usable as the curable resin material 13, as mentioned above.

FIG. 3B depicts the step of pressing the stamper 5 against the transfer target 105.

In this step, the curable resin material 13 deforms corresponding to the concavo-convex pattern of the microscopic structure layer 4. This allows transfer of the concavo-convex pattern of the microscopic structure layer 4 to the curable resin material 13.

FIG. 3C depicts the step of applying an ultraviolet ray 14 while pressing the stamper 5 against the transfer target 105.

In an embodiment illustrated in FIG. 3C, the ultraviolet ray 14 passing through the stamper 5 is applied to the curable resin material 13. Specifically, the curable resin material 13 employs a photocurable resin. Accordingly, the base material 1 and the microscopic structure layer 4 constituting the stamper 5 are composed of materials which allow the ultraviolet ray 14 to pass therethrough. The ultraviolet ray 14 for use herein has a wavelength of preferably from 200 to 400 nm, and more preferably from 365 to 400 nm. The curable resin material 13 may also be a material which is curable by the action of visible light (wavelength: 400 to 700 nm).

FIG. 3D depicts the transfer target 105, from which the stamper 5 has been detached.

In the state illustrated in FIG. 3D, the curable resin material 13 has been cured and thereby maintains the transferred shape.

(Transfer Apparatus of Microscopic Structure)

Next, an embodiment of the transfer apparatus of a microscopic structure according to the present invention will be illustrated.

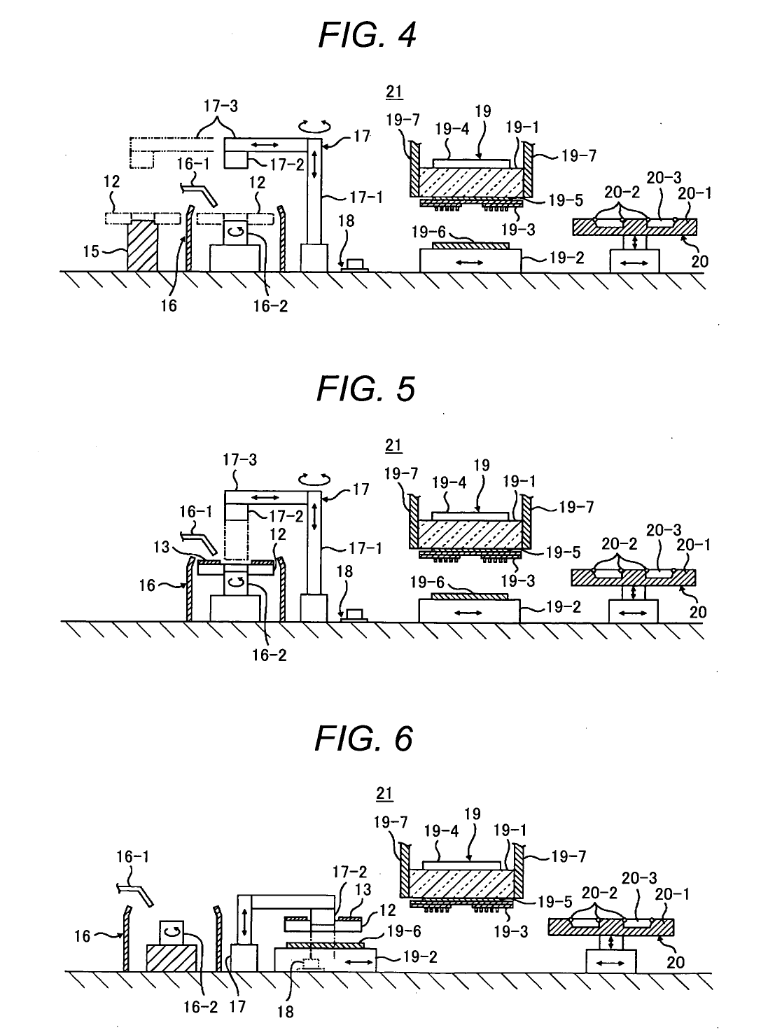

FIG. 4 is a schematic side view illustrating an exemplary configuration of a microscopic structure transfer mechanism in the transfer apparatus of a microscopic structure.

With reference to FIG. 4, the transfer apparatus of a microscopic structure according to the present invention includes a microscopic structure transfer mechanism 21 mainly including a resin coating mechanism 16, a substrate-handling mechanism 17, an aligning mechanism 18, a pressurizing mechanism 19, and a separating mechanism 20. The microscopic structure transfer mechanism of the transfer apparatus of a microscopic structure according to the present embodiment performs processes linearly from the resin coating mechanism 16 toward the separating mechanism 20.

<Resin Coating Mechanism>

The resin coating mechanism 16 of the transfer apparatus of a microscopic structure (hereinafter also simply referred to as “transfer apparatus”) is not limited, as long as being a mechanism capable of coating the surface of the substrate with a resin, and examples of such mechanisms include dispensing, ink-jet coating, spraying, and spin coating. Among them, spin coating enables uniform formation of a thin film on the entire surface of the substrate and is thereby preferred. When spin coating is employed, the mechanism is preferably one which enables the control of timing, position, and amount of dropping of the resin and enables the control of spin revolution and spin holding time, as well as time for the revolution to reach a predetermined value. This is preferred for the control of the thickness of the coated film.

<Substrate-Handling Mechanism>

The substrate-handling mechanism 17 of the transfer apparatus illustrated in FIG. 4 may employ a known or customary handling mechanism. Exemplary holding processes of the substrate include a process of mechanically holding an edge of the substrate; and a process of holding the surface or backside of the substrate through vacuum chucking. In FIG. 4, the reference signs “17-1” stands for a vertical handling arm capable of elevating and rotating; and “17-2” stands for a slidable horizontal handling arm. The slidable horizontal handling arm 17-3 is capable of moving above the resin coating mechanism 16, holding the transfer-target substrate 12 placed at a substrate-loading position 15, and then conveying the transfer-target substrate 12 to a spindle chuck 16-2 of the resin coating mechanism 16. Likewise, the slidable horizontal handling arm 17-3 is capable of conveying the substrate from the spindle chuck 16-2 of the resin coating mechanism 16 to a lower stage 19-2 of the aligning mechanism 18. A resin coating nozzle 16-1 feeds a predetermined resin solution (resin composition).

<Aligning Mechanism>

The aligning mechanism 18 of the transfer apparatus is a mechanism for aligning the relative position between the stamper and the transfer target so as to transfer the microscopic structure to a specific position on the transfer target. Specifically, the relative position between an alignment mark of the stamper and an alignment mark of the transfer-target substrate 12 or a specific portion such as an edge of the transfer-target substrate 12 is determined using an optical device such as a charge coupled device (CCD), and either one of the stamper and the transfer-target substrate 12 is moved according to a predetermined algorithm and thus aligned. Besides, when a series of the transfer-target substrates 12 have a constant identical shape, the mechanism may be a mechanism which mechanically holds a predetermined edge of the substrate for further simple alignment.

<Pressurizing Mechanism>

The pressurizing mechanism 19 of the transfer apparatus has mechanisms of pressing the stamper 5 against the transfer-target substrate 12 on which the resin has been applied, and curing the resin. The pressurizing mechanism 19 includes an upper head 19-1 and a lower stage 19-2. The upper head 19-1 can be supported typically by support arms 19-7. Upon pressurization, either the upper head 19-1 or the lower stage 19-2 is vertically moved to perform pressurization. In this case, the support arms 19-7 may be connected to a suitable elevating mechanism. Exemplary thrusts for the pressurization include a combination of a ball screw and a motor; pneumatic pressure; and oil-hydraulic pressure. The pressurizing mechanism 19 of the transfer apparatus according to the present invention has a pressurizing thrust which is suitably controllable and is from about 10 N to about 1 kN. A preferred example of the control procedure is a feedback control using a load cell. In addition, the lower stage 19-2 of the pressurizing mechanism 19 herein has a structure movable in a direction parallel to the moving direction of the transfer-target substrate 12 in the transfer apparatus. The upper head 19-1 of the pressurizing mechanism 19 herein includes an ultraviolet ray irradiation mechanism 19-4 for the curing of the resin. In another embodiment, the ultraviolet ray irradiation mechanism 19-4 may be arranged in the lower stage 19-2. In still another embodiment, a cushioning layer 19-6 composed of an elastic substance may be provided on the top of the lower stage 19-2. The use of such a cushioning layer is preferred for absorbing the waviness of the transfer-target substrate 12 and the stamper and for achieving uniform pressurization. In addition to these components, the pressurizing mechanism 19 for use in the present invention may further include a parallelism-regulating mechanism (not shown) for ensuring the parallelism between the upper head 19-1 and the lower stage 19-2.

<Stamper Having Microscopic Structure Layer>

A stamper 19-3 including a microscopic structure layer and belonging to the transfer apparatus of a microscopic structure is the stamper 5 for transfer of a microscopic structure which includes the base material 1 and, on a surface thereof, the microscopic structure layer 4.

<Separating Mechanism>

The separating mechanism 20 of the transfer apparatus is provided to separate the transfer-target substrate 12 from the stamper 19-3, in which the separation is performed after pressurizing the stamper 19-3 against the substrate, thereby bringing them into intimate contact with each other, and curing the resin. The apparatus has a following mechanism upon separation. Specifically, the separating mechanism 20 moves below the substrate being in intimate contact with the stamper 19-3, and either the separating mechanism 20 or the upper head 19-1 vertically moves to bring the transfer-target substrate 12 and the separating mechanism 20 into contact with each other and to allow the transfer-target substrate 12 to be fixed to the separating mechanism 20, thereafter either the upper head 19-1 or the separating mechanism 20 vertically moves again to thereby separate the transfer-target substrate 12 from the stamper 19-3. Exemplary preferred ways of the separating mechanism 20 to fix the substrate include mechanical holding of an edge of the transfer-target substrate 12; vacuum chucking; and electrostatic chucking (electrostatic attraction). An upper cushioning layer 19-5 is provided between the upper head 19-1 and the stamper 19-3. The separating mechanism 20 includes a separating chuck 20-1 on which O-rings 20-2 and suction cavities 20-3 are provided so as to bring only the edge of the transfer-target substrate 12 into contact therewith.

It should be noted that the configuration of the transfer apparatus as in FIG. 4 is illustrated only by way of example, and the stamper according to the present invention may be adopted to other transfer apparatuses for a microscopic structure for use in nanoimprinting, by which advantages of the stamper according to present invention are available. Such transfer apparatuses to which the stamper is adopted are not limited, as long as including at least a pair of pressurizing stages having a pressurizing mechanism; and a heating mechanism for softening the transfer target or a light source for curing a photocurable resin of the transfer target.

The stamper 5 according to the present embodiment as mentioned above enables highly accurate continuous transfer without requiring a mold-release treatment with respect to the transfer target, because the stamper includes the microscopic structure layer 4 provided on a surface of the base material 1, which microscopic structure layer 4 is composed of a polymer (cured article) derived from a resin composition containing a silsesquioxane derivative and, according to necessity, one or more other monomer components as principal components. In a preferred embodiment, the stamper 5 has further satisfactory releasability by forming the microscopic structure layer 4 using a silsesquioxane derivative having a curing mechanism different from that of the curable resin material 13 for constituting the transfer target. The stamper 5, which enables more satisfactory continuous transfer without requiring a mold-release treatment as above, may simplify manufacturing steps or processes of the microscopic structure and may reduce the process cost due to reduction in running costs. Also a transfer apparatus of a microscopic structure equipped with the stamper may enjoy significant cost reduction typically because the apparatus mechanism is simplified and the running costs thereof are reduced due to the elimination of a mold-release treatment step. In addition, the use of the transfer apparatus equipped with the stamper as illustrated in FIG. 4 enables highly accurate, automatically repeatable transfer operations.

The present invention has been described with reference to embodiments thereof. It should be noted, however, the present invention is not limited to these embodiments, and various modifications and alternations are possible in the present invention.

The stamper 5 described as the above embodiment is one including the microscopic structure layer 4 arranged on the surface of the base material 1. Such a stamper may further include another base or substrate on a surface of the base material 1 opposite to the microscopic structure layer 4.

FIG. 2B is a schematic view illustrating a stamper 5 for the transfer of a microscopic structure according to another embodiment of the present invention.

With reference to FIG. 2B, this stamper 5 includes a base material 1; a microscopic structure layer 4 provided on one side of the base material 1; an elastic plate 10 and an optically transparent rigid substrate 11 provided in this order on the other side of the base material 1. This stamper 5 is intended to use a photocurable resin composition as the curable resin material for the transfer target 105 in FIGS. 3A to 3D and employs the microscopic structure layer 4, the base material 1, and the elastic plate 10 each being optically transparent.

The elastic plate 10 is composed of a rubber member. Examples of the rubber member include synthetic rubbers such as urethane rubbers and silicone rubbers. The elastic plate 10 preferably has a thickness in the range of from 3 mm to 15 mm.

Examples of the optically transparent rigid substrate 11 include optically transparent glass plates, quartz plates, and plastic sheets. Exemplary plastic sheets include acrylic resin sheets and rigid poly(vinyl chloride) sheets. The optically transparent rigid substrate 11 preferably has a thickness in the range of from 10 mm to 30 mm.

The base material 1, the elastic plate 10, and the optically transparent rigid substrate 11 may be bonded with one another using an adhesive. The adhesive may be an optically transparent adhesive, and examples thereof include acrylic rubber optical adhesives and UV-curable polyester resins.

The elastic plate 10 and the optically transparent rigid substrate 11 may be mechanically bonded or joined with each other using a separately prepared jig (e.g., ring) or fixer (e.g., bolt). In another embodiment, a suction hole is formed in the optically transparent rigid substrate 11, and the elastic plate 10 is fixed to the rigid substrate 11 through suction via the suction hole using a suction pump. The suction and the mechanical bonding may be used in combination.

The stamper 5 in FIG. 2B as mentioned above, when pressed against the transfer target 105 (see FIGS. 3A to 3D) to transfer the microscopic structure, the microscopic structure layer 4 is pressed against the curable resin material 13 (see FIGS. 3A to 3D) under a uniform force by the action of elasticity of the elastic plate 10, and this enables highly accurate transfer of the microscopic structure to the curable resin material 13. In addition, inclusion of air between the microscopic structure layer 4 and the curable resin material 13 is more surely prevented, because the microscopic structure layer 4 is pressed against the curable resin material 13 (see FIGS. 3A to 3D) under a uniform force by the action of elasticity of the elastic plate 10.

The elastic plate 10, when having a thickness of 3 mm or more as mentioned above, allows the base material 1 and the microscopic structure layer 4 to deform sufficiently. This further improves the transfer accuracy of the microscopic structure. In a preferred embodiment, the elastic plate 10 has a thickness of 15 mm or less. When the stamper 5 according to this embodiment is used for transfer, the elastic plate is protected from deformation in the plane direction, whereby the base material 1 is more reliably protected from deviating in the longitudinal (horizontal) direction. This also further improves the transfer accuracy of the microscopic structure.

The stamper 5 illustrated in FIG. 2B shows further higher mechanical strength due to the rigidity exhibited by the optically transparent rigid substrate 11.

The optically transparent rigid substrate 11, when having a thickness of 10 mm or more as mentioned above, may impart sufficient mechanical strength to the stamper 5. The optically transparent rigid substrate 11, when having a thickness of 30 mm or less, may maintain its satisfactory optical transparency.

### EXAMPLES

Next, the present invention will be illustrated in further detail with reference to several working examples below. All parts and percentages in the following description are by mass, unless otherwise specified.

### Example 1

In this example, a stamper 5 for the transfer of a microscopic structure was prepared through the steps illustrated in FIGS. 1A to 1C.

<Preparation of Resin Composition 2>

Initially, a photocurable resin composition 2 for the formation of a microscopic structure layer 4 was prepared by blending 10 parts of OXSQ SI-20 (supplied by Toagosei Co., Ltd., indicated as “resin composition component SQ (a)” in Table 1, hereinafter the same) as a silsesquioxane derivative having two or more oxetanyl groups, with 0.6 part of a cationic-polymerization initiator ADEKA OPTOMER SP-172 (supplied by ADEKA CORPORATION) as in Table 1 mentioned later, and stirring them with a mix rotor to give a uniform mixture. The ADEKA OPTOMER SP-172 is not shown in Table 1, but was added in an identical amount to all resin compositions prepared as below.

<Preparation of Stamper for Transfer of Microscopic Structure>

Next, as the base material 1, a glass plate 20 mm long, 20 mm wide, and 0.7 mm thick was prepared, whose surface had been treated through vapor deposition of an epoxy-containing silane coupling agent KBM-403 (supplied by Shin-Etsu Silicones (a division of Shin-Etsu Chemical Co., Ltd.)). In this process, KBM-403 was used in an amount of 10 μl (microliters), and a vacuum deposition chamber had a volume of 0.1 m³. The treated surface of the base material 1 was coated with 10 μl of the resin composition 2 for the formation of the microscopic structure layer 4 (see FIG. 1A). Next, a silicon (Si) master mold 3 was prepared, whose surface had been treated with a release agent OPTOOL DSX (supplied by Daikin Industries Ltd.) (see FIG. 1A). A microscopic structure formed on the master mold 3 was a line-and-space pattern having a land width of 50 nm, a pitch of 90 nm, and a height of 50 nm.

Next, with reference to FIG. 1B, an ultraviolet ray having a wavelength of 365 nm was applied from the base material 1 side at an irradiation intensity of 60 mW/cm² for 480 seconds to cure the resin composition 2, while pressing the master mold 3 against the resin composition 2 at a pressure loading of 0.1 MPa. The irradiation was performed using an ultraviolet irradiation device SP-7 (supplied by Ushio Inc.) equipped with an ultrahigh-pressure mercury lamp. In this process, the distance between the master mold 3 and the base material 1 was regulated to be 30 μm. Next, with reference to FIG. 1C, the master mold 3 was fixed through vacuum chucking and then separated from the cured resin composition 2 (see FIG. 1B) to form the microscopic structure layer 4 on the surface of the base material 1. Thus, the stamper 5 according to this example was prepared. The stamper 5 had a bilayer structure (indicated as “stamper structure” in Table 1) including the base material 1 and the microscopic structure layer 4.

Next, of the microscopic structure layer 4, the modulus of elasticity [Pa], the thickness [μm], the contact angle [degree], the percentage of curing shrinkage [%], and the inorganic fraction [percent by mass] were determined. The results are shown in Table 1.

<Transfer of Microscopic Structure>

Next, continuous transfer was performed using the above-prepared stamper 5. As the transfer target in FIGS. 3A to 3D, a transfer target including a 2-inch silicon wafer as the transfer-target substrate 12 and, coated on a surface thereof, a photo-induced radically polymerizable resin composition as the curable resin material 13, which resin composition contained an acrylate monomer as a principal component. In this example, the silicon wafer as the transfer-target substrate 12 had been coated with the curable resin material 13 by spin coating. The spin coating had been performed at a mass of coating of 0.5 ml and a spin revolution of 5000 rpm for a spin time of 15 seconds. The silicon wafer used herein had been subjected to a surface treatment through vapor deposition of an acrylate-containing silane coupling agent KBM-5103 according to the procedure of the surface treatment for the base material 1.

Next, the conformability, releasability, and durability of the stamper 5 were evaluated.

<Evaluation of Conformability>

The conformability was evaluated in the following manner.

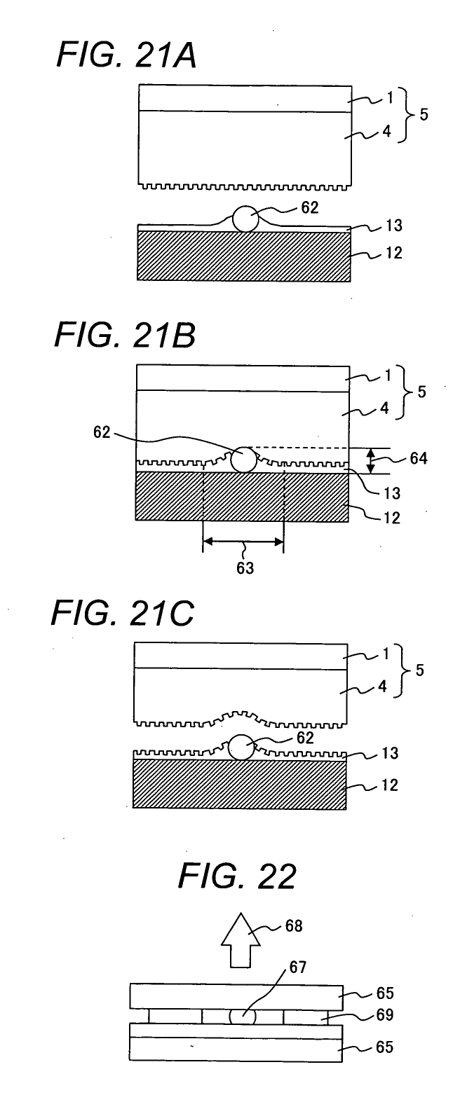

After a surface of the transfer-target substrate 12 was coated with the curable resin material 13 by spin coating, a series of silica beads 62 was dispersed on the surface of the coated film of the curable resin material 13 (see FIG. 21A), then the stamper 5 was pressed from above against the curable resin material 13 at a pressure loading of about 0.1 MPa to thereby perform transfer of the microscopic structure (see FIG. 21B). The curable resin material onto which the microscopic structure had been transferred was evaluated by measuring a non-contact length 63 around the silica bead 62 using a scanning electron microscope and a laser microscope. The evaluation was performed while using three types of silica beads 62, i.e., those having diameters of 0.1, 1, and 10 μm, respectively. The ratio of the non-contact length 63 to a silica bead height 64 was calculated as the index for conformability (see FIG. 21C). A sample having the ratio of less than 3 was evaluated as having good conformability, whereas a sample having the ratio of 3 or more was evaluated as having poor conformability. In Table 1 and Table 2, a sample having very good conformability is indicated as “Excellent”, a sample having good conformability is indicated as “Good”, and a sample having poor conformability is indicated as “Poor”.

<Evaluation of Releasability>

The releasability was evaluated in the following manner.

Initially, a flat cured resin layer of the resin composition 2 for the formation of the stamper 5 was formed on a surface of a glass substrate 65 whose surface had been treated with KBM-403. Then the curable resin material 13 was dropped thereto in an amount of 0.5 μl, against which a second glass substrate was pressed, and an ultraviolet ray was applied to cure the curable resin material. The surface of the second glass substrate had been treated with KBM-5103 (supplied by Shin-Etsu Silicones (a division of Shin-Etsu Chemical Co., Ltd.)). The treatment with KBM-5103 had been performed through vacuum deposition, as with KBM-403. The pressing of the glass substrates was performed while ensuring a gap of 50 μm between them using a gap-forming tape 69, and a curable resin 67 having a thickness of about 50 μm in the form of a droplet with a diameter of about 1.5 mm was formed (see FIG. 22). In that state, an ultraviolet ray having a wavelength of 365 nm was applied at an irradiation intensity of 60 mW/cm² for 480 seconds using an ultraviolet irradiation device SP-7 (supplied by Ushio Inc.) equipped with an ultrahigh-pressure mercury lamp, to cure the liquid curable resin. Next, tensile force was applied in a release direction 68 from the glass substrate treated with KBM-5103 at a rate of 0.5 mm/s to thereby peel the cured article layer of the resin composition from the curable resin material, and a force (release force) at the time of peeling was measured and defined as an index of releasability. A sample requiring a release force of less than 2 MPa was evaluated as having good releasability, whereas a sample requiring a release force of 2 MPa or more was evaluated as having poor releasability. In Table 1 and Table 2, a sample having very good releasability is indicated as “Excellent”, a sample having good releasability is indicated as “Good”, and a sample having poor releasability is indicated as “Poor”.

<Evaluation of Durability>

The durability was evaluated in the following manner.

Transfer operation of a microscopic structure to the curable resin material 13 was continuously repeated a total of 50 times using the stamper 5, and the durability of the stamper 5 was evaluated. A sample in which the shape of the microscopic structure of the microscopic structure layer 4 in the stamper 5 was satisfactorily maintained even after 50 transfer operations was evaluated as having good durability; whereas a sample in which the microscopic structure of the microscopic structure layer 4 had been broken was evaluated as having poor durability. In Table 1, a sample having very good durability is indicated as “Excellent”, a sample having good durability is indicated as “Good”, and a sample having poor durability is indicated as “Poor”. A sample having poor releasability and thereby being incapable of undergoing durability evaluation is indicated as “-”.

### Example 2

In this example, a stamper 5 for the transfer of a microscopic structure including a microscopic structure layer 4 was prepared by the procedure of Example 1. Specifically, the stamper 5 was prepared by the procedure of Example 1, except for preparing a resin composition 2 to be used by using 10 parts of a silsesquioxane derivative having eight epoxy groups, SQ-4 OG (supplied by Toagosei Co., Ltd., indicated as “resin composition component SQ (b)” in Table 1, hereinafter the same). Table 1 shows the modulus of elasticity [Pa] of the microscopic structure layer 4 derived from the above-prepared resin composition 2, the thickness [μm] of the microscopic structure layer, the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 1.

### Example 3

In this example, a stamper 5 for the transfer of a microscopic structure including a microscopic structure layer 4 was prepared by the procedure of Example 1. Specifically, the stamper 5 was prepared by the procedure of Example 1, except for preparing a resin composition 2 to be used by using 10 parts of a silsesquioxane derivative having three epoxy groups Tris[(epoxy-propoxypropyl)dimethylsilyloxy]-POSS® (supplied by ALDRICH, indicated as “resin composition component SQ (c)” in Table 1; hereinafter the same). Table 1 shows the modulus of elasticity [Pa] of the microscopic structure layer 4 derived from the above-prepared resin composition 2, the thickness [μm] of the microscopic structure layer, the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 1.

### Example 4

In this example, a stamper 5 for the transfer of a microscopic structure including a microscopic structure layer 4 was prepared by the procedure of Example 1. Specifically, the stamper 5 was prepared by the procedure of Example 1, except for preparing a resin composition 2 to be used by using the silsesquioxane derivative OXSQ SI-20 (supplied by Toagosei Co., Ltd.) indicated as SQ (a) in Table 1 in an amount of 9 parts, and further using a polydimethylsiloxane (PDMS) (supplied by Shin-Etsu Silicones (a division of Shin-Etsu Chemical Co., Ltd.), indicated as “monomer component (a)” in Table 1; hereinafter the same) in an amount of 1 part. The polydimethylsiloxane used herein has two epoxy groups and is cationically polymerizable as with the silsesquioxane derivative. Table 1 shows the modulus of elasticity [Pa] of the microscopic structure layer 4 derived from the above-prepared resin composition 2, the thickness [μm] of the microscopic structure layer, the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 1.

### Example 5

In this example, a stamper 5 for the transfer of a microscopic structure including a microscopic structure layer 4 was prepared by the procedure of Example 1. Specifically, the stamper 5 was prepared by the procedure of Example 1, except for preparing a resin composition 2 to be used by using the silsesquioxane derivative OXSQ SI-20 (supplied by Toagosei Co., Ltd.) indicated as SQ (a) in Table 1 in an amount of 9 parts, and further using EPIKOTE (now jER) 828 (supplied by Japan Epoxy Resins Co., Ltd. (now part of Mitsubishi Chemical Corporation), indicated as “monomer component (b)” in Table 1; hereinafter the same) in an amount of 1 part. The EPIKOTE 828 is a bisphenol-A epoxy resin having two epoxy groups and being cationically polymerizable as with the silsesquioxane derivative. Table 1 shows the modulus of elasticity [Pa] of the microscopic structure layer 4 derived from the above-prepared resin composition 2, the thickness [μm] of the microscopic structure layer, the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 1.

### Example 6

In this example, a stamper 5 for the transfer of a microscopic structure including a microscopic structure layer 4 was prepared by the procedure of Example 1. Specifically, the stamper 5 was prepared by the procedure of Example 1, except for preparing a resin composition 2 to be used by using the silsesquioxane derivative OX-SQ SI-20 (supplied by Toagosei Co., Ltd.) indicated as SQ (a) in Table 1 in an amount of 9 parts, and further using 3-ethyl-3-{[3-ethyloxetane-3-yl]methoxymethyl}oxetane (supplied by Toagosei Co., Ltd., indicated as “monomer component (c)” in Table 1; hereinafter the same) in an amount of 1 part. Table 1 shows the modulus of elasticity [Pa] of the microscopic structure layer 4 derived from the above-prepared resin composition 2, the thickness [μm] of the microscopic structure layer, the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 1.

### Example 7

In this example, a stamper 5 for the transfer of a microscopic structure including a microscopic structure layer 4 was prepared by the procedure of Example 1. Specifically, the stamper 5 was prepared by the procedure of Example 1, except for preparing a resin composition 2 to be used by using the silsesquioxane derivative OX-SQ SI-20 (supplied by Toagosei Co., Ltd.) indicated as SQ(a) in Table 1 in an amount of 7 parts, and further using 3-ethyl-3-{[3-ethyloxetane-3-yl]methoxymethyl}oxetane (supplied by Toagosei Co., Ltd.; “monomer component (c)” in Table 1) in an amount of 3 parts. Table 1 shows the modulus of elasticity [Pa] of the microscopic structure layer 4 derived from the above-prepared resin composition 2, the thickness [μm] of the microscopic structure layer, the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 1.

### Example 8

In this example, a stamper 5 for the transfer of a microscopic structure including a microscopic structure layer 4 was prepared by the procedure of Example 1. Specifically, the stamper 5 was prepared by the procedure of Example 1, except for preparing a resin composition 2 to be used by using the silsesquioxane derivative OX-SQ SI-20 (supplied by Toagosei Co., Ltd.) indicated as SQ(a) in Table 1 in an amount of 6 parts, and further using 3-ethyl-3-{[3-ethyloxetane-3-yl]methoxymethyl}oxetane (supplied by Toagosei Co., Ltd.; “monomer component (c)” in Table 1) in an amount of 4 parts. Table 1 shows the modulus of elasticity [Pa] of the microscopic structure layer 4 derived from the above-prepared resin composition 2, the thickness [μm] of the microscopic structure layer, the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 1.

### Example 9

In this example, a stamper 5 for the transfer of a microscopic structure including a microscopic structure layer 4 was prepared by the procedure of Example 1. Specifically, the stamper 5 was prepared by the procedure of Example 1, except for preparing a resin composition 2 to be used by using the silsesquioxane derivative OX-SQ SI-20 (supplied by Toagosei Co., Ltd.) indicated as SQ(a) in Table 1 in an amount of 9 parts, and further using a diepoxy having a perfluoro skeleton, i.e., 1,4-bis(2,3-epoxypropyl)perfluorobutane (supplied by Daikin Industries Ltd., indicated as “monomer component (d)” in Table 1; hereinafter the same) in an amount of 1 part. Table 1 shows the modulus of elasticity [Pa] of the microscopic structure layer 4 derived from the above-prepared resin composition 2, the thickness [μm] of the microscopic structure layer, the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 1.

### Example 10

In this example, a stamper 5 for the transfer of a microscopic structure including a microscopic structure layer 4 was prepared by the procedure of Example 1. Specifically, the stamper 5 was prepared by the procedure of Example 1, except for preparing a resin composition 2 to be used by using the silsesquioxane derivative OX-SQ SI-20 (supplied by Toagosei Co., Ltd.) indicated as SQ(a) in Table 1 in an amount of 7 parts and further using a diepoxy having a perfluoro skeleton, i.e., 1,4-bis(2,3-epoxypropyl)perfluorobutane (supplied by Daikin Industries Ltd., “monomer component (d)” in Table 1) in an amount of 3 parts. Table 1 shows the modulus of elasticity [Pa] of the microscopic structure layer 4 derived from the above-prepared resin composition 2, the thickness [μm] of the microscopic structure layer, the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 1.

TABLE 1

| | | | | | | | | | | | Example |
|---|---|---|---|---|---|---|---|---|---|---|---|
| | | Example 1 | Example 2 | Example 3 | Example 4 | Example 5 | Example 6 | Example 7 | Example 8 | Example 9 | 10 |
| Material | SQ (a) | 10 | — | — | 9 | 9 | 9 | 7 | 6 | 9 | 7 |
| composition | SQ (b) | — | 10 | — | — | — | — | — | — | — | — |
| | SQ (c) | — | — | 10 | — | — | — | — | — | — | — |
| | SQ (d) | — | — | — | — | — | — | — | — | — | — |
| | Monomer | — | — | — | 1 | — | — | — | — | — | — |
| | component (a) | | | | | | | | | | |
| | Monomer | — | — | — | — | 1 | — | — | — | — | — |
| | component (b) | | | | | | | | | | |
| | Monomer | — | — | — | — | — | 1 | 3 | 4 | — | — |
| | component (c) | | | | | | | | | | |
| | Monomer | — | — | — | — | — | — | — | — | 1 | 3 |
| | component (d) | | | | | | | | | | |
| | Monomer | — | — | — | — | — | — | — | — | — | — |
| | component (e) | | | | | | | | | | |
| | Monomer | — | — | — | — | — | — | — | — | — | — |
| | component (f) | | | | | | | | | | |

| | | | | | | | | | | |
|---|---|---|---|---|---|---|---|---|---|---|
| Modulus of elasticity of | 0.6 | 0.5 | 0.6 | 0.4 | 0.7 | 0.9 | 1.1 | 1.1 | 1.1 | 1.2 |
| microscopic structure layer | | | | | | | | | | |
| (GPa) | | | | | | | | | | |
| Thickness of microscopic | 30 | 30 | 30 | 30 | 30 | 30 | 30 | 30 | 30 | 30 |
| structure layer (μm) | | | | | | | | | | |
| Thickness of cushioning layer | 0 | 0 | 0 | 0 | 0 | 0 | 0 | 0 | 0 | 0 |
| (μm) | | | | | | | | | | |
| Contact angle (degree) | 99 | 88 | 93 | 100 | 86 | 98 | 96 | 95 | 101 | 100 |
| Percentage of curing | 5.0 | 4.1 | 4.0 | 4.3 | 4.8 | 4.9 | 4.7 | 4.9 | 4.9 | 5.0 |
| shrinkage (%) | | | | | | | | | | |
| Inorganic fraction (%) | 32 | 24 | 24 | 38 | 29 | 29 | 22 | 19 | 29 | 22 |
| Stamper structure (number of | 2 | 2 | 2 | 2 | 2 | 2 | 2 | 2 | 2 | 2 |
| layers) | | | | | | | | | | |
| Conformability | Excellent | Excellent | Excellent | Excellent | Excellent | Excellent | Excellent | Excellent | Excellent | Excellent |
| Releasability | Good | Good | Good | Excellent | Good | Good | Good | Good | Excellent | Excellent |
| Durability | Good | Good | Good | Good | Good | Excellent | Excellent | Excellent | Excellent | Excellent |

### Example 11

In this example, a stamper 5 for the transfer of a microscopic structure including a microscopic structure layer 4 was prepared by the procedure of Example 1. Specifically, the stamper 5 was prepared by the procedure of Example 1, except for preparing a resin composition 2 to be used by using the silsesquioxane derivative OX-SQ SI-20 (supplied by Toagosei Co., Ltd., indicated as “resin composition component SQ (a)” in Table 2; hereinafter the same) in an amount of 7 parts, and further using 3-ethyl-3-{[3-ethyloxetane-3-yl]methoxymethyl}oxetane (supplied by Toagosei Co., Ltd., indicated as “monomer component (c)” in Table 2; hereinafter the same) in an amount of 2 parts, and 1,4-bis(2,3-epoxypropyl)perfluorobutane as a diepoxy having a perfluoro skeleton (supplied by Daikin Industries Ltd., indicated as “monomer component (d)” in Table 2; hereinafter the same) in an amount of 1 part. Table 2 shows the modulus of elasticity [Pa] of the microscopic structure layer 4 derived from the above-prepared resin composition 2, the thickness [μm] of the microscopic structure layer, the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 2.

### Example 12

In this example, a stamper 5 for the transfer of a microscopic structure including a microscopic structure layer 4 was prepared by the procedure of Example 1. Specifically, the stamper 5 was prepared by the procedure of Example 1, except for preparing a resin composition 2 to be used by using the silsesquioxane derivative OX-SQ SI-20 (supplied by Toagosei Co., Ltd., “resin composition component SQ (a)” in Table 2) in an amount of 9 parts and further using 1,4-butanediol divinyl ether (supplied by Nippon Carbide Industries, Co., Inc., indicated as “monomer component (e)” in Table 2; hereinafter the same) in an amount of 1 part. Table 2 shows the modulus of elasticity [Pa] of the microscopic structure layer 4 derived from the above-prepared resin composition 2, the thickness [μm] of the microscopic structure layer, the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 2.

### Example 13

In this example, a resin composition 2 as with Example 1 was prepared.

A stamper for the transfer of a microscopic structure was then prepared in the following manner (not shown in the drawings).

Initially, a master mold as with Example 1, which had been subjected to a mold-release treatment with OPTOOL DSX (supplied by Daikin Industries Ltd.), was prepared.

Next, the above-prepared resin composition 2 was applied by spin coating to a side of the master mold on which a microscopic structure had been formed, and the applied resin composition was cured by irradiation with an ultraviolet ray having a wavelength of 365 nm at an irradiation intensity of 60 mW/cm² for 480 seconds. The spin coating was performed at a dropping amount of the resin composition 2 of 0.5 ml and a spin revolution of 5000 rpm for a spin time of 90 seconds.

Next, a photocurable epoxy resin was applied to a surface of the layer of the cured resin composition 2 by spin coating and the applied epoxy resin was cured while pressing glass as an optically transparent, highly elastic base material 1 thereagainst. The surface of the base material 1 to be in contact with the epoxy resin had been subjected to a surface treatment by vacuum deposition of KBM-403 (supplied by Shin-Etsu Silicones (a division of Shin-Etsu Chemical Co., Ltd.)) and a subsequent heating treatment. In this process, KBM-403 was used in an amount of 10 μl, a vacuum deposition chamber had a volume of 0.1 m³, and the heating had been performed at a temperature of 125° C. for a duration of 10 minutes.

Next, by separating the master mold therefrom, the stamper 5 was obtained. This had a three-layer structure (indicated as “stamper structure” in Table 2) including, in the following order, a microscopic structure layer composed of the cured article of the resin composition of Example 1; the support layer (cushioning layer) composed of the cured epoxy resin; and the glass plate (20 mm long, 20 mm wide, and 0.7 mm thick) as the base material 1. The total thickness of the final microscopic structure layer including the support layer was regulated to be 30 μm.

The support layer in the above-prepared stamper had elasticity lower than that of the microscopic structure layer 4. The glass plate had an elasticity higher than those of the microscopic structure layer 4 and the support layer. Table 2 shows the modulus of elasticity [Pa] of the microscopic structure layer 4 derived from the above-prepared resin composition 2, the thicknesses [μm] of the microscopic structure layer and of the cushioning layer (support layer), the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 2.

### Example 14

In this example, a resin composition 2 as with Example 9 was prepared, and using the prepared resin composition, a stamper 5 for the transfer of a microscopic structure was prepared by the procedure of Example 13.

Table 2 shows the modulus of elasticity [Pa] of the microscopic structure layer 4 derived from the above-prepared resin composition 2, the thicknesses [μm] of the microscopic structure layer and of the cushioning layer (support layer), the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 2.

### Example 15

In this example, a resin composition 2 as with Example 1 was prepared.

A stamper for the transfer of a microscopic structure was then prepared in the following manner (not shown in the drawings).

Initially, a master mold as with Example 1 which had been subjected to a mold-release treatment with OPTOOL DSX (supplied by Daikin Industries Ltd.) was prepared.

Next, the above-prepared resin composition 2 was applied by spin coating to a side of the master mold on which a microscopic structure had been formed, and the applied resin composition was cured by irradiation with an ultraviolet ray having a wavelength of 365 nm at an irradiation intensity of 60 mW/cm² for 480 seconds. The spin coating was performed at a dropping amount of the resin composition 2 of 0.5 ml and a spin revolution of 5000 rpm for a spin time of 90 seconds.

Next, a photocurable unsaturated polyester was applied by spin coating to a surface of the layer of the cured resin composition 2, the applied photocurable unsaturated polyester was cured by irradiation with an ultraviolet ray, and thereby yielded a first support layer (first cushioning layer).

Next, a photocurable epoxy resin was applied to the surface of the first support layer by spin coating, the applied epoxy resin was cured while pressing a glass plate as an optically transparent, highly elastic base material 1 against the coated layer of the epoxy resin, and thereby yielded a second support layer between the first support layer and the base material 1. The surface of the base material 1 to be in contact with the epoxy resin had been subjected to a coupling treatment with KBM-403 (supplied by Shin-Etsu Silicones (a division of Shin-Etsu Chemical Co., Ltd.)).

Next, by separating the master mold therefrom, the stamper was obtained. This had a four-layer structure (indicated as “stamper structure” in Table 2) including, in the following order, a microscopic structure layer 4 composed of the cured article of the resin composition of Example 1; the first support layer (first cushioning layer) composed of the cured unsaturated polyester; the second support layer (second cushioning layer) composed of the cured epoxy resin; and the glass plate (20 mm long, 20 mm wide, and 0.7 mm thick) as the highly elastic base material 1.

In the above-prepared stamper, the first support layer had elasticity lower than that of the microscopic structure layer 4; the second support layer had elasticity lower than that of the first support layer; and the glass base had an elasticity higher than that of the second support layer.

Table 2 shows the modulus of elasticity [Pa] of the microscopic structure layer 4 derived from the above-prepared resin composition 2, the thicknesses [μm] of the microscopic structure layer and of the cushioning layers (support layers), the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 2.

### Example 16

In this example, a resin composition 2 as with Example 9 was prepared, and using the prepared resin composition, a stamper 5 for the transfer of a microscopic structure was prepared by the procedure of Example 15.

Table 2 shows the modulus of elasticity [Pa] of the microscopic structure layer 4 derived from the above-prepared resin composition 2, the thicknesses [μm] of the microscopic structure layer and of the cushioning layers (support layers), the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 2.

### Example 17

In this example, a resin composition 2 as with Example 1 was prepared. A stamper for the transfer of a microscopic structure was then prepared in the following manner (not shown in the drawings).

Initially, a master mold as with Example 1, which had been subjected to a mold-release treatment with OPTOOL DSX (supplied by Daikin Industries Ltd.), was prepared.

Next, the above-prepared resin composition 2 was applied by spin coating to a side of the master mold on which a microscopic structure had been formed, and the applied resin composition was cured by irradiation with an ultraviolet ray having a wavelength of 365 nm at an irradiation intensity of 60 mW/cm² for 480 seconds. The spin coating was performed at a dropping amount of the resin composition 2 of 0.5 ml and a spin revolution of 5000 rpm for a spin time of 90 seconds.

Next, a photocurable unsaturated polyester was applied to a surface of the layer of the cured resin composition 2 by spin coating, the applied photocurable unsaturated polyester was cured by irradiation with an ultraviolet ray, and thereby yielded a first support layer (first cushioning layer).

Next, a photocurable unsaturated polyester was applied to the surface of the first support layer by spin coating, the applied photocurable unsaturated polyester was cured by irradiation with an ultraviolet ray, and thereby yielded a second support layer (second cushioning layer).

Next, a photocurable epoxy resin was applied to the surface of the second support layer by spin coating, the applied epoxy resin was then cured while pressing a glass plate as an optically transparent, highly elastic base material 1 against the coated layer of the epoxy resin, and thereby yielded a third support layer (third cushioning layer) between the second support layer and the base material 1. The surface of the base material 1 to be in contact with the epoxy resin had been subjected to a coupling treatment with KBM-403 (supplied by Shin-Etsu Silicones (a division of Shin-Etsu Chemical Co., Ltd.)).

By separating the master mold therefrom, the stamper 5 was prepared. This had a five-layer structure (indicated as “stamper structure” in Table 2) including, in the following order, a microscopic structure layer 4 composed of the cured article of the resin composition of Example 1; the first support layer composed of the cured epoxy resin; the second support layer composed of the cured unsaturated polyester; the third support layer composed of the cured epoxy resin; and the glass plate (20 mm long, 20 mm wide, and 0.7 mm thick) as the highly elastic base material 1.

In the prepared stamper 5, the first support layer had elasticity lower than that of the microscopic structure layer 4; the second support layer had an elasticity lower than that of the first support layer; and the glass-made base material 1 had an elasticity higher than that of the second support layer.

Table 2 shows the modulus of elasticity [Pa] of the microscopic structure layer 4 derived from the above-prepared resin composition 2, the thicknesses [μm] of the microscopic structure layer and of the cushioning layers (support layers), the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 2.

### Example 18

In this example, a resin composition 2 as with Example 9 was prepared, and using the prepared resin composition, a stamper 5 for the transfer of a microscopic structure was prepared by the procedure of Example 17.

Table 2 shows the modulus of elasticity [Pa] of the microscopic structure layer 4 derived from the above-prepared resin composition 2, the thicknesses [μm] of the microscopic structure layer and of the cushioning layers (support layers), the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 2.

### Example 19

In this example, a resin composition 2 as with Example 1 was prepared.

A stamper for the transfer of a microscopic structure was then prepared in the following manner (not shown in the drawings).

Initially, a master mold as with Example 1 which had been subjected to a mold-release treatment with OPTOOL DSX (supplied by Daikin Industries Ltd.) was prepared.

Next, the above-prepared resin composition 2 was applied by spin coating to a side of the master mold on which a microscopic structure had been formed, and the applied resin composition was cured by irradiation with an ultraviolet ray having a wavelength of 365 nm at an irradiation intensity of 60 mW/cm² for 480 seconds. The spin coating was performed at a dropping amount of the resin composition 2 of 0.5 ml and a spin revolution of 5000 rpm for a spin time of 90 seconds.

Table 2 shows the modulus of elasticity [Pa] of the microscopic structure layer 4 derived from the above-prepared resin composition 2, the thicknesses [μm] of the microscopic structure layer and of the cushioning layers (support layers), the contact angle [degree], the percentage of curing shrinkage [%], and the inorganic fraction [percent by mass].

Next, the cured resin composition layer was separated from the master mold. The resulting resin composition layer was used as a microscopic structure layer 4 in FIG. 2B. Independently, a base material 1, an elastic plate 10, and an optically transparent rigid substrate 11 illustrated in FIG. 2B were prepared. By stacking these members one on another with the interposition of an adhesive in the order as in FIG. 2B, the stamper 5 was prepared.

The base material 1 used herein was a glass plate (20 mm long, 20 mm wide, and 0.7 mm thick); the elastic plate 10 was a silicone rubber (supplied by Dow Corning Toray Co., Ltd., SYLGARD (registered trademark), 10 mm thick) ; and the optically transparent rigid substrate 11 was a quartz substrate (0.7 mm thick).

The above-prepared stamper 5 was subjected to tests by the procedure of Example 1, whereby the conformability, releasability, and durability of the stamper 5 were evaluated. The results are shown in Table 2.

### Example 20

In this example, a resin composition 2 as with Example 9 was prepared, and using the prepared resin composition, a stamper 5 for the transfer of a microscopic structure was prepared by the procedure of Example 19.

Table 2 shows the modulus of elasticity [Pa] of the microscopic structure layer 4 derived from the above-prepared resin composition 2, the thicknesses [μm] of the microscopic structure layer and of the cushioning layers (support layers), the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 2.

TABLE 2

| | | Example | Example | Example | Example | Example | Example | Example | Example | Example | Example |
|---|---|---|---|---|---|---|---|---|---|---|---|
| | | 11 | 12 | 13 | 14 | 15 | 16 | 17 | 18 | 19 | 20 |
| Material | SQ (a) | 7 | 9 | 10 | 9 | 10 | 9 | 10 | 9 | 10 | 9 |
| composition | SQ (b) | — | — | — | — | — | — | — | — | — | — |
| | SQ (c) | — | — | — | — | — | — | — | — | — | — |
| | SQ (d) | — | — | — | — | — | — | — | — | — | — |
| | Monomer | — | — | — | — | — | — | — | — | — | — |
| | component (a) | | | | | | | | | | |
| | Monomer | — | — | — | — | — | — | — | — | — | — |
| | component (b) | | | | | | | | | | |
| | Monomer | 2 | — | — | — | — | — | — | — | — | — |
| | component (c) | | | | | | | | | | |
| | Monomer | 1 | — | — | 1 | — | 1 | — | 1 | — | 1 |
| | component (d) | | | | | | | | | | |
| | Monomer | — | 1 | — | — | — | — | — | — | — | — |
| | component (e) | | | | | | | | | | |
| | Monomer | — | — | — | — | — | — | — | — | — | — |
| | component (f) | | | | | | | | | | |

| | | | | | | | | | | |
|---|---|---|---|---|---|---|---|---|---|---|
| Modulus of elasticity of | 1.3 | 0.8 | 0.6 | 1.1 | 0.6 | 1.1 | 0.6 | 1.1 | 0.6 | 1.1 |
| microscopic structure layer | | | | | | | | | | |
| (GPa) | | | | | | | | | | |
| Thickness of microscopic | 30 | 30 | 5 | 5 | 5 | 5 | 5 | 5 | 5 | 5 |
| structure layer (μm) | | | | | | | | | | |
| Thickness of cushioning layer | 0 | 0 | 25 | 25 | 25 | 25 | 25 | 25 | 25 | 25 |
| (μm) | | | | | | | | | | |
| Contact angle (degree) | 99 | 95 | 99 | 101 | 99 | 101 | 99 | 101 | 99 | 101 |
| Percentage of curing | 4.7 | 4.8 | 5.0 | 4.9 | 5.0 | 4.9 | 5.0 | 4.9 | 5.0 | 4.9 |
| shrinkage (%) | | | | | | | | | | |
| Inorganic fraction (%) | 22 | 29 | 32 | 29 | 32 | 29 | 32 | 29 | 32 | 29 |
| Stamper structure (number of | 2 | 2 | 3 | 3 | 4 | 4 | 5 | 5 | 4 | 4 |
| layers) | | | | | | | | | | |
| Conformability | Excellent | Excellent | Excellent | Excellent | Excellent | Excellent | Excellent | Excellent | Excellent | Excellent |
| Releasability | Excellent | Good | Good | Excellent | Good | Excellent | Good | Excellent | Good | Excellent |
| Durability | Excellent | Excellent | Good | Excellent | Good | Excellent | Good | Excellent | Good | Excellent |

### Comparative Example 1

In this comparative example, a stamper 5 for the transfer of a microscopic structure including a microscopic structure layer 4 was prepared by the procedure of Example 1. Specifically, the stamper 5 was prepared by the procedure of Example 1, except for preparing a resin composition 2 to be used by using a silsesquioxane derivative having a radically polymerizable acrylic group, i.e., ACSQ (supplied by Toagosei Co., Ltd., indicated as “resin composition component SQ (d)” in Table 3; hereinafter the same) in an amount of 10 parts. Table 3 shows the modulus of elasticity [Pa] of the microscopic structure layer 4 derived from the above-prepared resin composition 2, the thickness [μm] of the microscopic structure layer, the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 3.

TABLE 3

| | | Com. | Com. | Com. | Com. | Com. | Com. | Com. | Com. | |
|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Com. Ex. 9 |
| Material | SQ (a) | — | — | 7.5 | 7.5 | — | — | 7.5 | 7.5 | — |
| composition | SQ (b) | — | — | — | — | — | — | — | — | — |
| | SQ (c) | — | — | — | — | — | — | — | — | — |
| | SQ (d) | 10 | — | — | — | 10 | 10 | — | — | — |
| | Monomer component (a) | — | 10 | 2.5 | — | — | — | 2.5 | — | — |
| | Monomer component (b) | — | — | — | 2.5 | — | — | — | 2.5 | — |
| | Monomer component (c) | — | — | — | — | — | — | — | — | — |
| | Monomer component (d) | — | — | — | — | — | — | — | — | — |
| | Monomer component (e) | — | — | — | — | — | — | — | — | — |
| | Monomer component (f) | — | — | — | — | — | — | — | — | 10 |

| | | | | | | | | | |
|---|---|---|---|---|---|---|---|---|---|
| Modulus of elasticity of microscopic | 1.0 | 0.03 | 0.3 | 0.7 | 1.0 | 1.0 | 0.3 | 0.7 | 2.0 |
| structure layer (GPa) | | | | | | | | | |
| Thickness of microscopic structure | 30 | 30 | 30 | 30 | 5 | 5 | 5 | 5 | 30 |
| layer (μm) | | | | | | | | | |
| Thickness of cushioning layer (μm) | 0 | 0 | 0 | 0 | 25 | 25 | 25 | 25 | 0 |
| Contact angle (degree) | 82 | 98 | 99 | 81 | 82 | 82 | 99 | 81 | 75 |
| Percentage of curing shrinkage (%) | 8.9 | 3.5 | 4.0 | 4.5 | 8.9 | 8.9 | 4.0 | 4.5 | 12.1 |
| Inorganic fraction (%) | 32 | 40 | 38 | 23 | 32 | 32 | 38 | 23 | 0 |
| Stamper structure (number of layers) | 2 | 2 | 2 | 2 | 3 | 4 | 3 | 3 | 2 |
| Conformability | Excellent | Excellent | Excellent | Excellent | Excellent | Excellent | Excellent | Excellent | Poor |
| Releasability | Poor | Excellent | Excellent | Poor | Poor | Poor | Excellent | Poor | Poor, |
| | | | | | | | | | requiring |
| | | | | | | | | | mold-release |
| | | | | | | | | | treatment |
| Durability | — | Poor | Poor | — | — | — | Poor | — | Poor |

### Comparative Example 2

In this comparative example, a stamper 5 for the transfer of a microscopic structure including a microscopic structure layer 4 was prepared by the procedure of Example 1. Specifically, the stamper 5 was prepared by the procedure of Example 1, except for preparing a resin composition 2 to be used by using a polydimethylsiloxane (PDMS) having two cationically polymerizable epoxy groups (supplied by Shin-Etsu Silicones (a division of Shin-Etsu Chemical Co., Ltd.), indicated as “monomer component (a)” in Table 3; hereinafter the same) in an amount of 10 parts. Table 3 shows the modulus of elasticity [Pa] of the microscopic structure layer 4 derived from the above-prepared resin composition 2, the thickness [μm] of the microscopic structure layer, the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 3.

### Comparative Example 3

In this comparative example, a stamper 5 for the transfer of a microscopic structure including a microscopic structure layer 4 was prepared by the procedure of Example 1. Specifically, the stamper 5 was prepared by the procedure of Example 1, except for preparing a resin composition 2 to be used by using the silsesquioxane derivative OXSQ SI-20 (supplied by Toagosei Co., Ltd., “resin composition component SQ (a)” in Table 3) in an amount of 7.5 parts, and further using the polydimethylsiloxane (PDMS) (supplied by Shin-Etsu Silicones (a division of Shin-Etsu Chemical Co., Ltd.), “monomer component (a)” in Table 3) in an amount of 2.5 parts. The polydimethylsiloxane has two epoxy groups and is cationically polymerizable as with the silsesquioxane derivative. Table 3 shows the modulus of elasticity [Pa] of the microscopic structure layer 4 derived from the above-prepared resin composition 2, the thickness [μm] of the microscopic structure layer, the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 3.

### Comparative Example 4

In this comparative example, a stamper 5 for the transfer of a microscopic structure including a microscopic structure layer 4 was prepared by the procedure of Example 1. Specifically, the stamper 5 was prepared by the procedure of Example 1, except for preparing a resin composition 2 to be used by using the silsesquioxane derivative OXSQ SI-20 (supplied by Toagosei Co., Ltd., “resin composition component SQ (a)” in Table 3) in an amount of 7.5 parts, and further using EPIKOTE (now jER) 828 (supplied by Japan Epoxy Resins Co., Ltd. (now part of Mitsubishi Chemical Corporation), indicated as “monomer component (b)” in Table 3; hereinafter the same) in an amount of 2.5 parts. The EPIKOTE 828 is a bisphenol-A epoxy resin having two epoxy groups and being cationically polymerizable as with the silsesquioxane derivative. Table 3 shows the modulus of elasticity [Pa] of the microscopic structure layer 4 derived from the above-prepared resin composition 2, the thickness of the microscopic structure layer [μm], the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 3.

### Comparative Example 5

In this comparative example, a resin composition as with Comparative Example 1 was prepared, and using the prepared resin composition, a stamper 5 for the transfer of a microscopic structure was prepared by the procedure of Example 13.

Table 3 shows the modulus of elasticity [Pa] of the microscopic structure layer 4 derived from the above-prepared resin composition 2, the thicknesses [μm] of the microscopic structure layer and of the cushioning layers, the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 3.

### Comparative Example 6

In this comparative example, a resin composition as with Comparative Example 2 was prepared, and using the prepared resin composition, a stamper 5 for the transfer of a microscopic structure was prepared by the procedure of Example 13.

Table 3 shows the modulus of elasticity [Pa] of the microscopic structure layer 4 derived from the above-prepared resin composition 2, the thicknesses [μm] of the microscopic structure layer and of the cushioning layers, the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 3.

### Comparative Example 7

In this comparative example, a resin composition as with Comparative Example 3 was prepared, and using the prepared resin composition, a stamper 5 for the transfer of a microscopic structure was prepared by the procedure of Example 13.

Table 3 shows the modulus of elasticity [Pa] of the microscopic structure layer 4 derived from the above-prepared resin composition 2, the thicknesses [μm] of the microscopic structure layer and of the cushioning layers, the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 3.

### Comparative Example 8

In this comparative example, a resin composition as with Comparative Example 4 was prepared, and using the prepared resin composition, a stamper 5 for the transfer of a microscopic structure was prepared by the procedure of Example 13.

Table 3 shows the modulus of elasticity [Pa] of the microscopic structure layer 4 derived from the above-prepared resin composition 2, the thicknesses [μm] of the microscopic structure layer and of the cushioning layers, the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 3.

### Comparative Example 9

In this comparative example, a stamper 5 for the transfer of a microscopic structure including a microscopic structure layer 4 was prepared by the procedure of Example 1. Specifically, the stamper 5 was prepared by the procedure of Example 1, except for preparing a resin composition 2 to be used by using an unsaturated polyester resin material (supplied by DH Material Inc., indicated as “monomer component (f)” in Table 3; hereinafter the same) in an amount of 10 parts.

Table 3 shows the modulus of elasticity [Pa] of the microscopic structure layer 4 derived from the above-prepared resin composition 2, the thickness [μm] of the microscopic structure layer, the contact angle [degree], the percentage of curing shrinkage [%], and the inorganic fraction [percent by mass].

The above-prepared stamper 5 was subjected to tests by the procedure of Example 1, whereby the conformability, releasability, and durability of the stamper 5 were evaluated. The results are shown in Table 3.

The data regarding Examples 1 to 20 and Comparative Examples 1 to 9 demonstrate that samples, when having a modulus of elasticity of the microscopic structure layer of from 0.03 to 1.9 GPa, show very good conformability; whereas samples, when having a modulus of elasticity of the microscopic structure layer of 2.0 GPa, show poor conformability. Regarding the releasability, samples show very good releasability when the resin composition contains the polydimethylsiloxane (monomer component (a) in Tables 1 and 2) in an amount of 1 part or contains the diepoxy having a perfluoro skeleton (monomer component (d) in Tables 1 and 2) in an amount of from 1 to 3 parts; samples show good releasability when the resin composition contains SQ (a), SQ (b), or SQ (c) alone without containing a monomer component; and samples show poor releasability when the resin composition contains a component not contributing to the releasability (monomer component (b) in Tables 1 and 2) in an amount of 2.5 parts or more. When the resin composition contains SQ (d) which is cured through the same mechanism as with the curable resin material, the resulting stamper shows poor releasability. Regarding the durability, samples show very good durability when the resin composition contains another monomer component than the polydimethylsiloxane (monomer component (a) in Tables 1 and 2) in an amount of from 1 to 4 parts, and the resulting cured article (microscopic structure layer) has a modulus of elasticity of 0.8 GPa or more; samples show good durability when the microscopic structure layer has a modulus of elasticity of from 0.4 to 0.7 GPa; and samples show poor durability when the microscopic structure layer has a modulus of elasticity of 0.3 GPa or less.

The above data demonstrate that the microscopic structure layer preferably has a modulus of elasticity of 0.8 to 1.9 GPa; and that such a microscopic structure layer having very good conformability, releasability, and durability is obtained by adding about 1 part to about 3 parts of a material having releasability, such as a polydimethylsiloxane or a diepoxy having a perfluoro skeleton, to the principal component silsesquioxane derivative.

### Examples 21 to 29

In these examples, a series of a stamper 5 for the transfer of a microscopic structure including a microscopic structure layer 4 was prepared by the procedure of Example 1. In this process, the microscopic structure layers 4 of the stampers 5 were controlled to have different thicknesses by regulating the amount of the resin composition 2 to be dropped and the relative position (distance) between the base material 1 and the master mold 3. Specifically, the series of the microscopic structure layers 4 had five different thicknesses of 0.2, 1, 5, 10, and 20 μm respectively.

The above-prepared stampers 5 were subjected to tests by the procedure of Example 1 to evaluate their conformability. The results are shown in Table 4.

### Examples 30 to 38

In these examples, a series of a stamper 5 for the transfer of a microscopic structure including a microscopic structure layer 4 was prepared by the procedure of Example 9. In this process, the microscopic structure layers 4 of the stampers 5 were controlled to have different thicknesses by regulating the amount of the resin composition 2 to be dropped and the relative position (distance) between the base material 1 and the master mold 3. Specifically, the series of the microscopic structure layers 4 had five different thicknesses of 0.2, 1, 5, 10, and 20 μm respectively.

The above-prepared stampers 5 were subjected to tests by the procedure of Example 1 to evaluate their conformability. The results are shown in Table 5.

### Comparative Examples 10 to 18

In these comparative examples, a series of a stamper 5 for the transfer of a microscopic structure including a microscopic structure layer 4 was prepared by the procedure of Example 1. In this process, the microscopic structure layers 4 of the stampers 5 were controlled to have different thicknesses by regulating the amount of the resin composition 2 to be dropped and the relative position between the base material 1 and the master mold 3. Specifically, the series of the microscopic structure layers 4 had five different thicknesses of 0.1, 0.2, 1, 5, and 10 μm.

The above-prepared stampers 5 were subjected to tests by the procedure of Example 1 to evaluate their conformability. The results are shown in Table 4.

### Comparative Examples 19 to 27

In these comparative examples, a series of a stamper 5 for the transfer of a microscopic structure including a microscopic structure layer 4 was prepared by the procedure of Example 9. In this process, the microscopic structure layers 4 of the stampers 5 were controlled to have different thicknesses by regulating the amount of the resin composition 2 to be dropped and the position between the base material 1 and the master mold 3. Specifically, the series of the microscopic structure layers 4 had five different thicknesses of 0.1, 0.2, 1, 5, and 10 μm respectively.

The above-prepared stampers 5 were subjected to tests by the procedure of Example 1 to evaluate their conformability. The results are shown in Table 5.

The results of Examples 21 to 38 and Comparative Examples 10 to 27 demonstrate that the microscopic structure layer, when having a thickness of 2 times or more the diameter of the beads, exhibits satisfactory conformability to reduce a poor transfer region; whereas the microscopic structure layer, when having a thickness of equal to or less than the diameter of the beads, has an insufficient cushioning action and thereby fails to exhibit satisfactory conformability. The data in Table 4 and those in Table 5 regard to samples having different moduli of elasticity of the microscopic structure layer but showed similar tendencies in results. This indicates that the conformability is not significantly affected by the modulus of elasticity at moduli of elasticity of the microscopic structure layer in the range of from about 0.6 to about 1.1 GPa but is significantly affected by the thickness of the microscopic structure layer.

TABLE 4

| | | Bead diameter (μm) | | |
|---|---|---|---|---|
| | | 0.1 | 1 | 10 |
| Stamper | 0.1 | Poor | Poor | Poor |
| thickness | | (Com. Ex. 10) | (Com. Ex. 11) | (Com. Ex. 14) |
| (μm) | 0.2 | Good | Poor | Poor |
| | | (Example 22) | (Com. Ex. 12) | (Com. Ex. 15) |
| | 1 | Good | Poor | Poor |
| | | (Example 23) | (Com. Ex. 13) | (Com. Ex. 16) |
| | 5 | Good | Good | Poor |
| | | (Example 24) | (Example 27) | (Com. Ex. 17) |
| | 10 | Good | Good | Poor |
| | | (Example 25) | (Example 28) | (Com. Ex. 18) |
| | 20 | Good | Good | Good |
| | | (Example 26) | (Example 29) | (Example 30) |
| | 30 | Good | Good | Good |
| | | (Example 1) | (Example 1) | (Example 1) |

TABLE 5

| | | Bead diameter (μm) | | |
|---|---|---|---|---|
| | | 0.1 | 1 | 10 |
| Stamper | 0.1 | Poor | Poor | Poor |
| thickness | | (Com. Ex. 19) | (Com. Ex. 20) | (Com. Ex. 23) |
| (μm) | 0.2 | Good | Poor | Poor |
| | | (Example 30) | (Com. Ex. 21) | (Com. Ex. 24) |
| | 1 | Good | Poor | Poor |
| | | (Example 31) | (Com. Ex. 22) | (Com. Ex. 25) |
| | 5 | Good | Good | Poor |
| | | (Example 32) | (Example 35) | (Com. Ex. 26) |
| | 10 | Good | Good | Poor |
| | | (Example 33) | (Example 36) | (Com. Ex. 27) |
| | 20 | Good | Good | Good |
| | | (Example 34) | (Example 37) | (Example 38) |
| | 30 | Good | Good | Good |
| | | (Example 9) | (Example 9) | (Example 9) |

### Example 39

An exemplary transfer of a microscopic structure using the transfer apparatus of a microscopic structure in FIG. 4 will be described with reference to FIGS. 5 to 14.

FIG. 5 is a schematic configuration diagram illustrating one step for the formation of a microscopic structure on a surface of a transfer-target substrate 12 using a microscopic structure transfer mechanism 21.

The transfer-target substrate 12 is mechanically held at an edge of disk inner peripheral opening by a disk (transfer-target substrate)-conveying chuck head 17-2 of the substrate-handling mechanism 17, is conveyed from the substrate-loading position 15 to the spindle chuck 16-2 of the resin coating mechanism 16, and is held at an edge of disk inner peripheral opening by the spindle chuck 16-2. Next, the resin coating nozzle 16-1 discharges 1 ml of a liquid resin material while the disk (substrate) is rotated at 700 rpm, and then the disk is rotated at 5000 rpm for 60 seconds, and thus a resin thin film is formed on the surface of the transfer-target substrate 12. The resin composition contains acrylic monomer and polymer components and a photo-induced radical reaction initiator and has a low viscosity.

FIG. 6 is a schematic configuration diagram illustrating a step subsequent to the step in FIG. 5.

The transfer-target substrate 12 on which the thin film of the curable resin material 13 has been formed is conveyed again by the transfer-target substrate-conveying chuck head 17-2 to the aligning mechanism 18. The lower stage 19-2 has been moved from the pressurizing mechanism 19 to the aligning mechanism 18 by the action of a moving device (not shown) such as a guide rail. The moving device may be composed of a guide rail to carry the lower stage, and a movement-driving mechanism to control the position of the lower stage which moves on the guide rail. On the lower stage 19-2, a lower cushioning layer 19-6 made of a silicone and having a thickness of 5 mm is provided. Next, an inner peripheral edge of the transfer-target substrate and an alignment mark of the lower stage 19-2 are optically recognized by an alignment CCD camera of the aligning mechanism 18, and the alignment between the transfer-target substrate 12 and the lower stage 19-2 is performed using an X-Y micro-moving mechanism mounted to the lower stage 19-2.

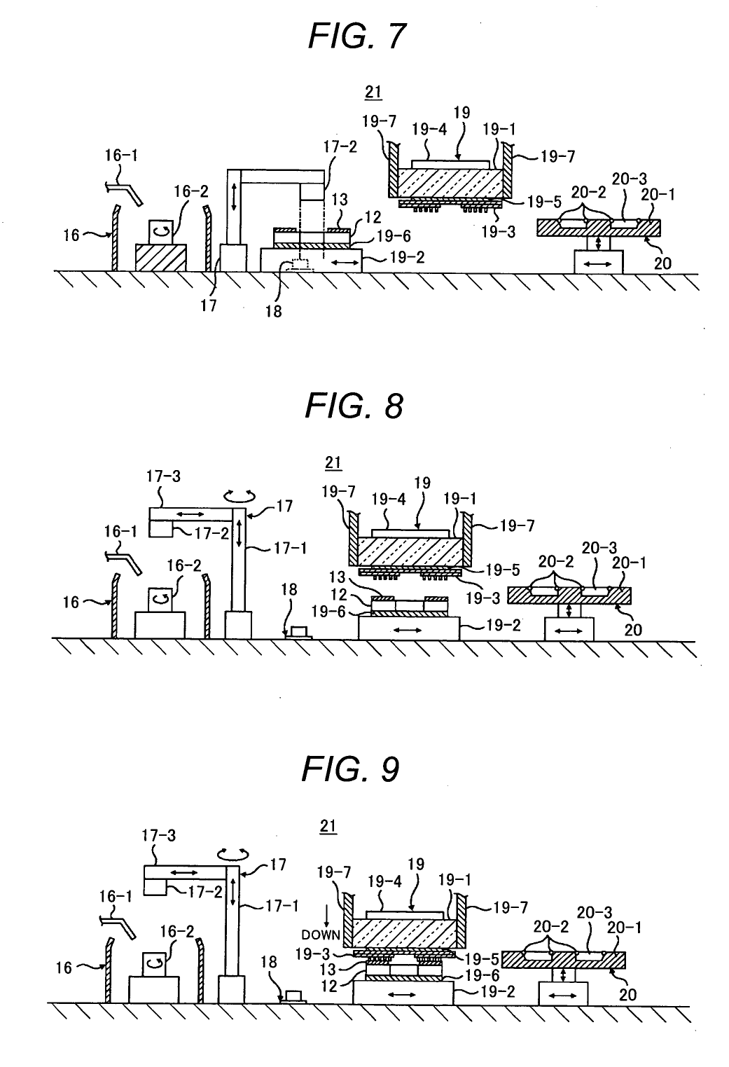

FIG. 7 is a schematic configuration diagram illustrating a step subsequent to the step in FIG. 6.

At the time when the alignment between the transfer-target substrate 12 and the lower stage 19-2 completes, the transfer-target substrate 12 is placed on the surface of the lower cushioning layer 19-6 on the lower stage 19-2 and is then fixed to the lower stage 19-2 typically through vacuum chucking. A clamp mechanism may be employed instead of the vacuum chucking to fix the transfer-target substrate 12 to the lower stage 19-2.

FIG. 8 is a schematic configuration diagram illustrating a step subsequent to the step in FIG. 7.

After the transfer-target substrate 12 is fixed to the lower stage 19-2, the lower stage 19-2, on which the transfer-target substrate 12 bearing the resin thin film is placed, is moved through the moving device to below the upper head 19-1 of the pressurizing mechanism 19. At the bottom of the upper head 19-1 of the pressurizing mechanism 19, there is mounted the stamper 19-3 with the interposition of the upper cushioning layer 19-5 made of a silicone and having a thickness of 5 mm. After the lower stage 19-2 is moved to below the upper head 19-1, the lower stage 19-2 is moved by a predetermined offset distance using the X-Y micro-moving mechanism to adjust the relative position with respect to the stamper 19-3.

FIG. 9 is a schematic configuration diagram illustrating a step subsequent to the step in FIG. 8.

The upper head 19-1 descends to the surface of the transfer-target substrate 12, which bears the thin film of the curable resin material, via a ball screw by the action of stepping motor control, pressurizes the same at a thrust of 90 N for 10 seconds, and then an ultraviolet (UV) is applied at 60 mW/cm² for 4 seconds from an LED-ultraviolet source 19-4 mounted in the upper head to cure the resin thin film. The stamper 19-3 used in this example has been prepared by the procedure of Example 9.

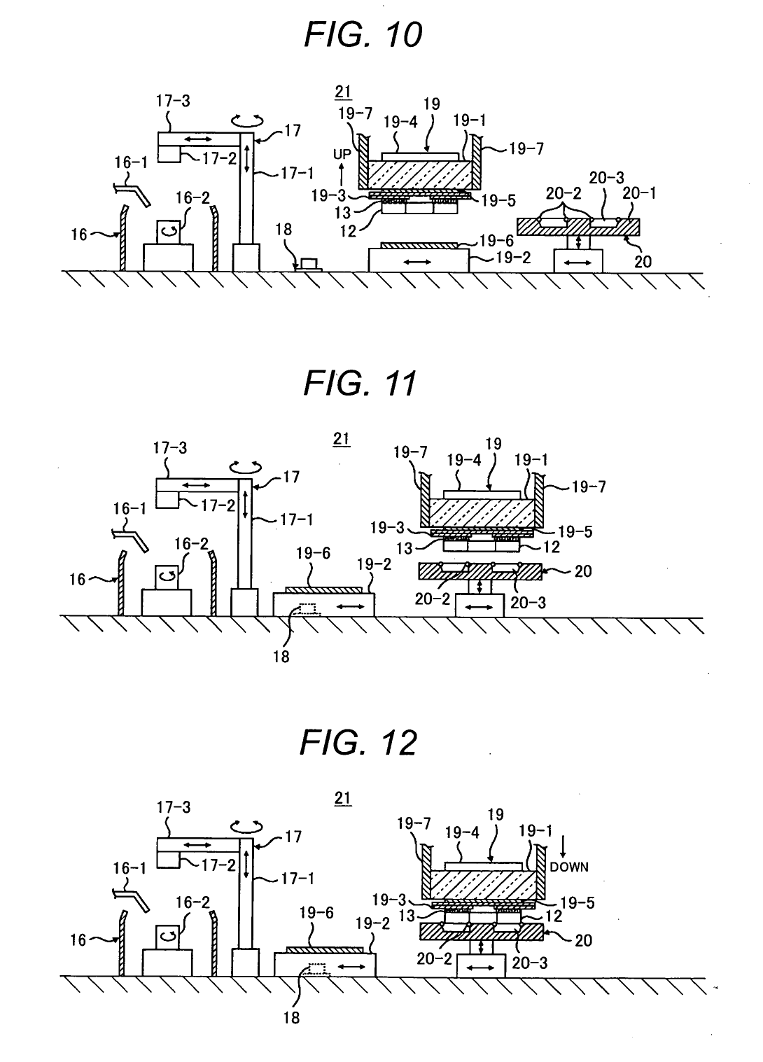

FIG. 10 is a schematic configuration diagram illustrating a step subsequent to the step in FIG. 9.

After the thin film of the curable resin material 13 is cured and the vacuum chucking of the transfer-target substrate 12 by the lower stage 19-2 is released, the upper stage (upper head) 19-1 ascends while the transfer-target substrate 12 is kept in intimate contact with the stamper 19-3.

FIG. 11 is a schematic configuration diagram illustrating a step subsequent to the step in FIG. 10.

Simultaneously with the retracting of the lower stage 19-2 toward the aligning mechanism 18, the separating chuck 20-1 of the separating mechanism 20 is moved through a moving device to directly below the transfer-target substrate 12 which is in intimate contact with the stamper 19-3 fixed to the upper head 19-1 of the pressurizing mechanism 19. The moving device may be composed of a guide rail to carry the releasing stage; and a movement-driving mechanism to control the position of the releasing stage which moves on the guide rail. On the separating chuck 20-1, O-rings 20-2 and suction cavities 20-3 are provided so as to bring only the edge of the transfer-target substrate 12 into contact therewith.

FIG. 12 is a schematic configuration diagram illustrating a step subsequent to the step in FIG. 11.

The upper head 19-1 of the pressurizing mechanism 19 descends to be in contact with the separating chuck 20-1 of the separating mechanism 20 and is adhered to the separating chuck 20-1 through vacuum chucking. In this process, the vacuum is not broken due to the presence of the O-rings.

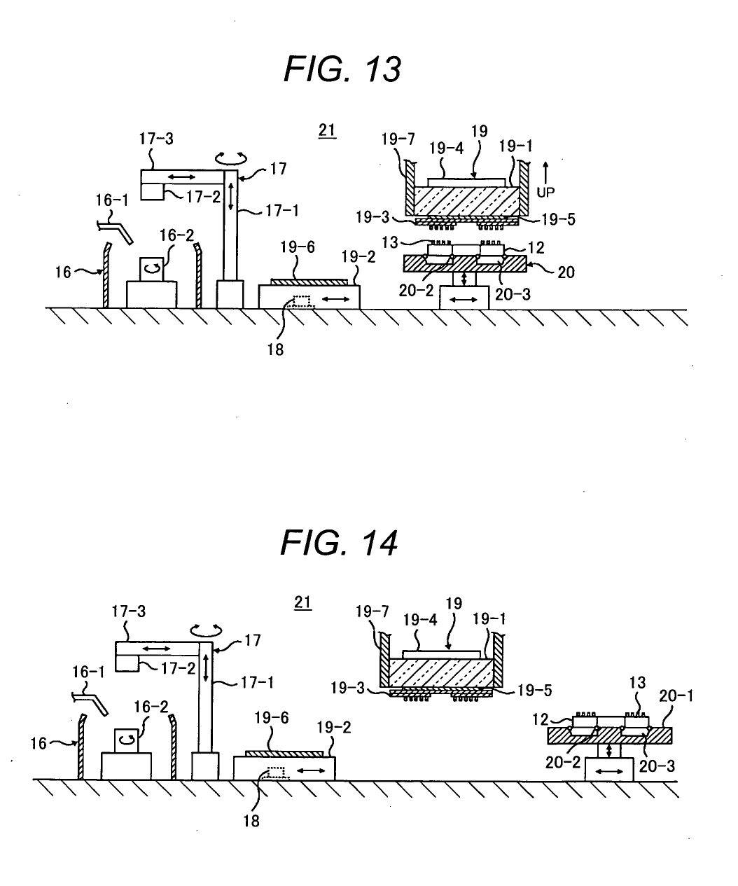

FIG. 13 is a schematic configuration diagram illustrating a step subsequent to the step in FIG. 12.

After the transfer-target substrate 12 is securely adhered to the separating chuck 20-1 through vacuum chucking and the upper head 19-1 again ascends, the transfer-target substrate 12 can be separated from the stamper 19-3.

FIG. 14 is a schematic configuration diagram illustrating a step subsequent to the step in FIG. 13.

While holding on its surface the transfer-target substrate 12 bearing a microscopic structure formed on the surface of the curable resin material 13, the separating chuck 20-1 of the separating mechanism 20 is moved from directly below the pressurizing mechanism 19 to a predetermined position for the separating mechanism 20, and thus the transfer is completed. Though not shown, the transfer-target substrate 12 bearing the transferred microscopic structure and being held by the separating chuck 20-1 is then delivered typically to a substrate discharging mechanism, and thus a series of operations is completed.

The transfer apparatus of a microscopic structure described in this example does not require a dedicated substrate-conveying mechanism, because the lower stage of the pressurizing mechanism and the separating chuck of the separating mechanism also serve to convey the substrate from the aligning mechanism to the separating mechanism. This saves the spaces for conveying mechanisms respectively between adjacent mechanisms ranging from the aligning mechanism to the substrate-conveying mechanism and reduces the footprint area of the apparatus. In addition, the above configuration shortens the time for the disk substrate to attach to and detach from respective mechanisms and thereby contributes to the improvements of productivity. Furthermore, the apparatus has such a configuration that the transfer-target substrate is brought into intimate contact with the stamper held below the upper head of the pressurizing mechanism, and this allows the lower stage of the pressurizing mechanism and the separating chuck of the separating mechanism to move below the transfer-target substrate. This configuration allows the linear movement of the disk substrate, allows the linear arrangement of all units, and thereby contributes to the reduction of the footprint area without suffering from dead space.

The transfer apparatus employs the stamper having a microscopic structure layer composed of a polymer derived from a resin composition containing a silsesquioxane derivative as a principal component, thereby eliminates the need for a mold-release treatment of the stamper, and reduces the deterioration of transfer accuracy of the microscopic structure in repeated transfer operations. The unnecessity of the mold-release treatment of the stamper may simplify the nanoimprinting process steps and the apparatus mechanism of the transfer apparatus of a microscopic structure and may enable significant cost reduction in the process and transfer apparatus of a microscopic structure. The configuration also lengthens the stamper's life and effectively contributes to the cost reduction due to reduced material cost and to the reduction of loads on the environment due to reduction in material consumption.

### Example 40

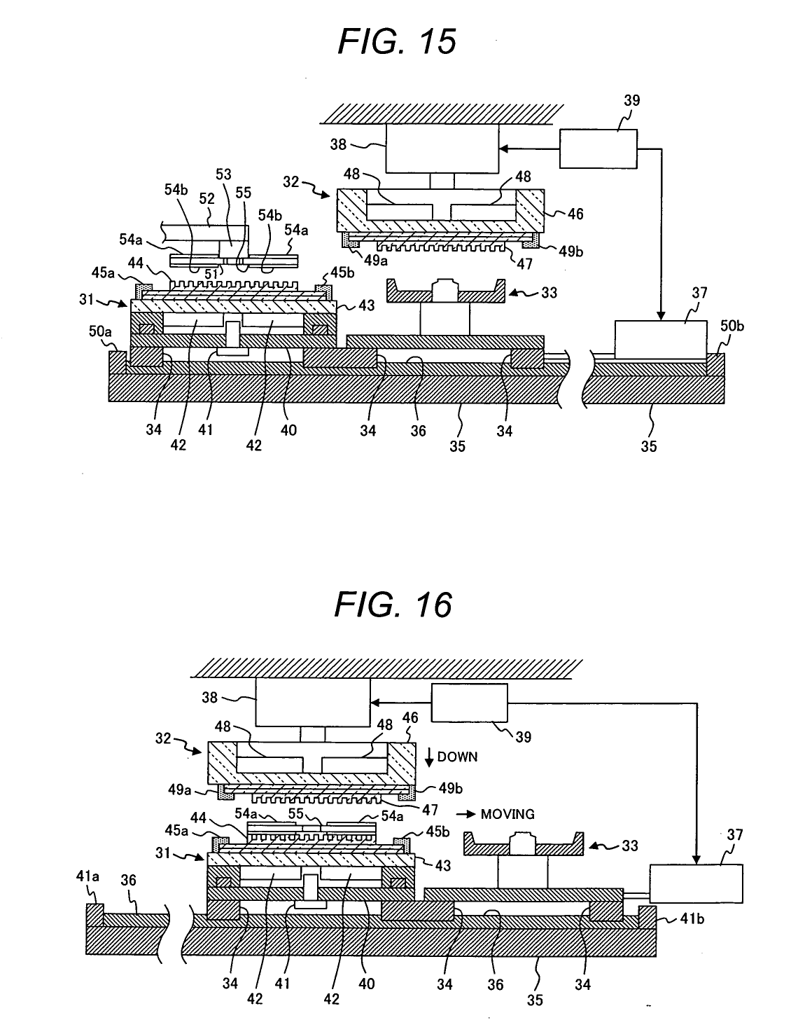

FIG. 15 is a schematic configuration diagram illustrating a step of forming microscopic structures on surfaces of a disk substrate by a microscopic structure transfer mechanism in a transfer apparatus of a double-sided microscopic structure, by which the step of forming a microscopic structure on a curable resin material on the disk substrate through the nanoimprinting technique is performed automatically on both sides of the disk substrate.

The disk substrate 51 bearing a photocurable resin material 54a, 54b coated on both sides thereof is conveyed by a disk substrate chuck 53 attached at the tip of a disk substrate-handling arm 52. The disk 51 is coated with the curable resin material 54a, 54b up to its outer peripheries, and thereby the disk outer peripheries may not be chucked. However, there is a region where the curable resin material is not coated in a portion around a through hole at the center of the disk 51, and the substrate (disk) 51 is preferably conveyed by holding the curable-resin-non-coated region 55 by the substrate chuck 53 through vacuum chucking. When the disk 51 is conveyed immediately above a lower stamper 44 by the substrate-handling arm 52, an alignment camera 41 of a lower stamper device 31 detects the center of inner bore of the disk 51 and an alignment mark at the center of the lower stamper 44, and, based on the detection signals, an X-Y micro-moving mechanism moves a stage 40 to thereby align the disk 51 and the lower stamper 44. After the alignment between the disk 51 and the lower stamper 44 is completed, the disk-handling arm 52 descends, thereby the disk 51 is placed on the surface of the lower stamper 44. The vacuum chuck of the disk chuck 53 is separated, and thereafter the disk-handling arm 52 is retracted. Exemplary ways to apply the curable resin material 13 to both sides of the disk 51 include known or customary processes such as spin coating, ink-jet coating, spray coating, and roll coating.

Examples of the disk 51 include toroidal disk-shaped substrates each having a through hole at the center thereof, such as hard disks (HDDs), compact discs (CDs), and digital versatile disks (DVDs). The surfaces of the disk 51 may have a multilayer structure by forming thereon a thin film such as a metal layer, resin layer, or oxide film layer according to necessity. Examples of principal components of the curable resin material 13 include cycloolefin polymers, poly(methyl methacrylate)s (PMMAs), polystyrenes, polycarbonates, poly(ethylene terephthalate)s (PETs), poly(lactic acid)s (PLAs), polypropylenes, polyethylenes, and poly(vinyl alcohol)s (PVAs). Exemplary photosensitive materials include peroxides, azo compounds (e.g., azobisisobutyronitrile), ketones (e.g., benzoin and acetone), diaminobenzene, metal complex salts, and dyestuffs. A thin film of liquid resin formed through coating of the curable resin material 13 is also called a “resist film”.

FIG. 16 is a partially schematic configuration diagram illustrating a step of a double-sided microscopic structure transfer operation by the transfer apparatus of a double-sided microscopic structure.

When the disk 51 bearing the curable resin material 13 coated on both sides thereof is placed on the top of the lower stamper 44 as described above with reference to FIG. 15, a movement-driving mechanism 37 moves a movable table 34 carrying the lower stamper device 31 and a transfer target separating device 33 (separating mechanism) along a guide rail 36, and the alignment camera of the lower stamper device 31 detects the alignment mark of the lower stamper 44 and the alignment mark of an upper stamper 47 and, based on the detection signals, the X-Y micro-moving mechanism moves the stage 40 to align the disk 51 and the upper stamper 47. After the alignment between the lower stamper 44 and the upper stamper 47 is completed, an elevating mechanism 38 descends the upper stamper device 32 and allows the upper stamper device 32 abut against the disk 51 to press the upper stamper device 32 against the disk 51 under a predetermined pressure. The movement-driving mechanism 37 and the elevating mechanism 38 are controlled by a control unit 39.

Next, ultraviolet rays are applied from an ultraviolet source 48 of the lower stamper device 31 and from an ultraviolet source 48 of the upper stamper device 32 to cure the curable resin material 13. This allows the microscopic structure of the lower stamper 44 to be transferred to the lower curable resin material of the disk 51 and allows the microscopic structure of the upper stamper 47 to be transferred to the upper curable resin material. The ultraviolet source 48 may be a known or customary ultraviolet source, and examples thereof usable herein include mercury lamps, high-pressure mercury lamps, low-pressure mercury lamps, xenon lamps, and UV-LED light sources. Among them, UV-LED light sources are preferred. Such an UV-LED light source is significantly reduced in size as compared to mercury lamps, emits an ultraviolet ray of over 365 nm, thereby suppresses the generation of heat, and does neither adversely affect nor damage the irradiation target. In addition, the UV-LED light source has advantages that it consumes little electric power, is thereby environmentally friendly, has a long life (10000 to 20000 time), and reduces the line stopping time for lamp exchange.

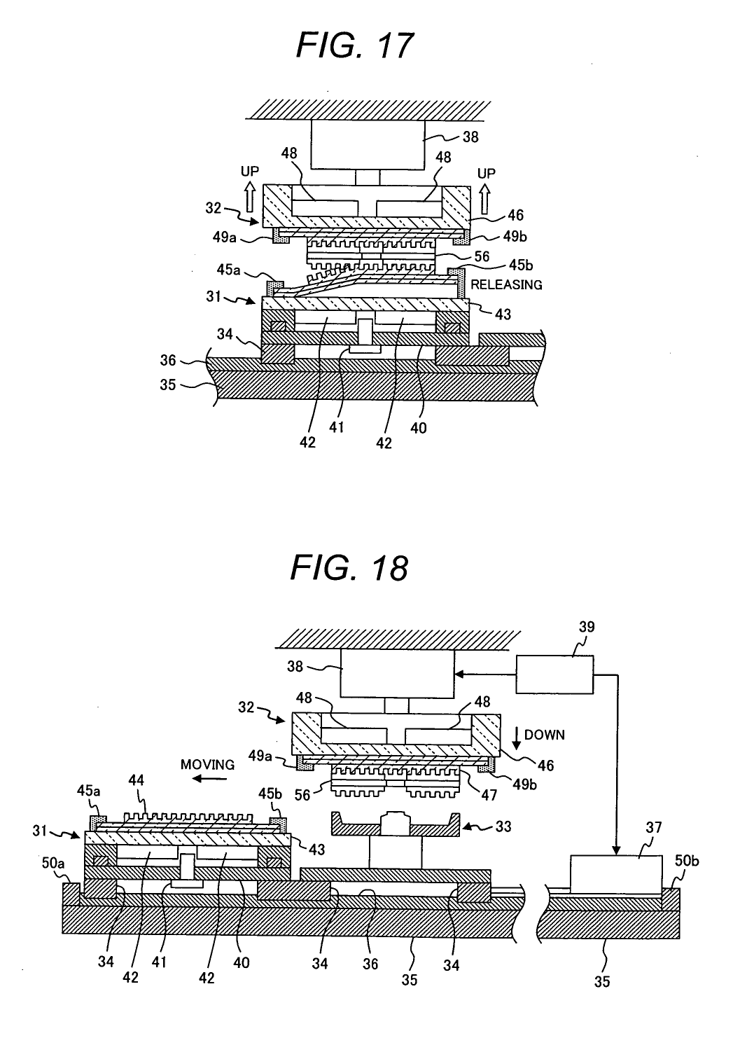

FIG. 17 is a partially schematic configuration diagram illustrating one step of the double-sided microscopic structure transfer operation by the transfer apparatus of a double-sided microscopic structure.

After the completion of the transfer of microscopic structures to both sides of the disk 51 as described above with reference to FIG. 16, the transferred disk 56 is recovered. In this process, initially, the upper stamper 47 is secured to a stamper-support table 46 by clamps 49a and 49b of the upper stamper device 32, whereas the lower stamper 44 is secured to a stamper-carrying stage 43 by clamps 45a and 45b of the lower stamper device 31. Under this condition, the secure by the clamp 45b is released, and the upper stamper device 32 is ascended. This allows the transferred disk 56 to be gradually separated from the lower stamper 44 from the still secured clamp 45a side, as illustrated in FIG. 17. If the separation is performed unlike the above-mentioned process in which one end of the work (disk) is first separated, namely, if the upper stamper device 32 is ascended while securing the upper stamper 47 by the clamps 49a and 49b and while securing the lower stamper 44 by the clamps 45a and 45b, the transferred disk cannot be smoothly and completely separated from the lower stamper 44 because of strong adhesion between the transferred disk 56 and each of the lower and upper stampers 44 and 47. In this case, if the transferred disk 56 is forcibly separated, this may mechanically damage the upper stamper 47, the lower stamper 44, and/or the transferred disk 56.

After the transferred disk 56 is separated from the lower stamper 44, the movement-driving mechanism 37 moves, along the guide rail 36, the lower stamper device 31 and the transfer-target separating device 33 fixed on the top of the movable table 34, as illustrated in FIG. 18. When the transfer-target separating device 33 is moved to a position to face the upper stamper device 32, the separating device 33 is stopped at the position. Next, the elevating mechanism 38 allows the upper stamper device 32 to descend and thereby brings the transferred disk 56 into intimate contact with the transfer-target separating device 33.

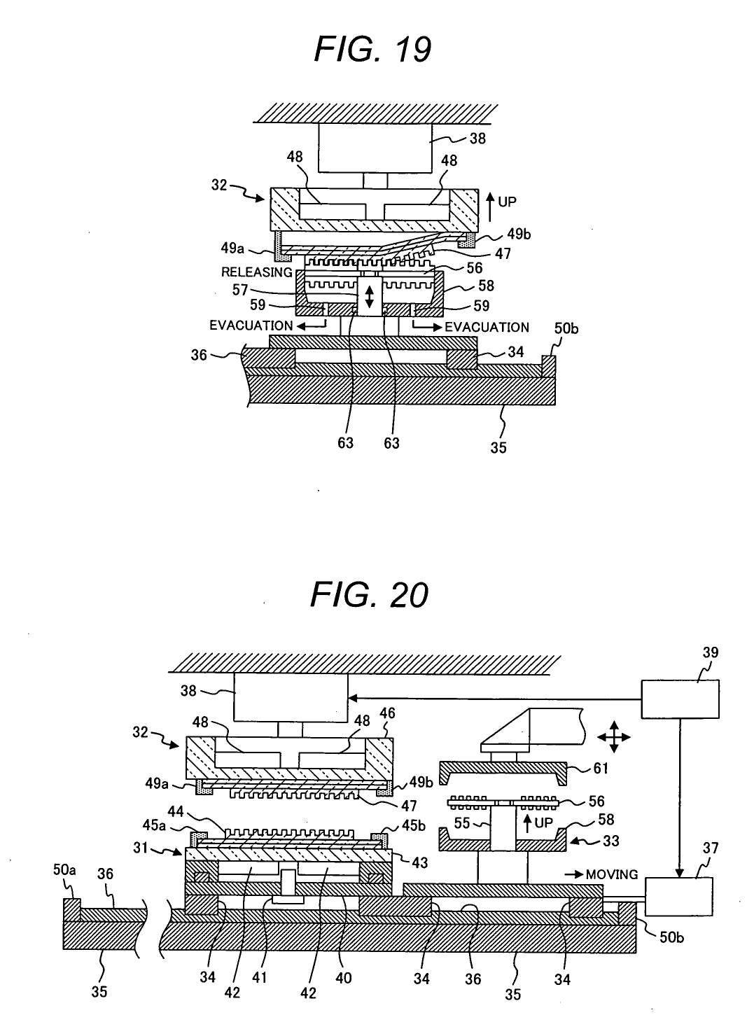

FIG. 19 is a schematic configuration diagram illustrating the separating mechanism of the transfer apparatus of a double-sided microscopic structure.

This figure shows how the transferred disk 56 is vacuum-chucked by a vacuum chuck unit 58. The vacuum chucking in the vacuum chuck unit 58 is performed by evacuation via evacuation ports 59.

As is illustrated in FIG. 19, the clamp 49a is slightly descended while the transferred disk 56 is held in intimate contact with the transfer-target separating device 33 through vacuum chucking and while one edge of the upper stamper 47 is fixed by the clamp 49b of the upper stamper device 32, to thereby release the secure of the edge of the upper stamper 47 opposite to the clamp 49a (near the clamp 49b). The transferred disk 56 is gradually separated from the upper stamper device 32 from the secured clamp 49b side, is ultimately completely separated from the upper stamper 47 and is held by the transfer-target separating device 33 while being vacuum chucked.

FIG. 20 is a partially schematic configuration diagram illustrating a final step of the double-sided microscopic structure transfer operation by the transfer apparatus of a double-sided microscopic structure.

After the transferred disk 56 is separated from the upper stamper 47, the lower stamper device 31 and the transfer-target separating device 33 fixedly installed on the movable table 34 are moved along the guide rail 36, and when they are moved to a position at which the lower stamper device 31 faces the upper stamper device 32, they are stopped at the position. The vacuum chucking by the vacuum chuck unit 58 of the transfer target separating mechanism 33 is stopped, and a disk support shaft 57 is ascended. The transferred disk 56 supported on the top of the disk support shaft 57 is then recovered by an unloader 61.

The transfer apparatus of a microscopic structure as described in this example enables a both-sided transfer of microscopic structures to a transfer target, in addition to advantageous effects obtained by the apparatus according to Example 39.

Finally, accompanying effects of the present invention will be described.

The present invention eliminates the need for a mold-release treatment of a resin stamper for the transfer of a microscopic structure, thereby simplifies the nanoimprinting process and the apparatus mechanism of the transfer apparatus of a microscopic structure, and significantly reduces the cost.

In addition, the present invention reduces the deterioration of transfer accuracy of microscopic structures in repeated transfer operations, thus lengthens the stamper life, and thereby reduces the material cost. In addition, the present invention reduces the material consumption and thereby reduces loads on the environment.

### EXPLANATION OF NUMERALS

1: base material, 2: resin composition, 3: master mold, 4: microscopic structure layer, 5: stamper for a transfer of a microscopic structure, 6: upper plate, 7: upper cushioning layer, 8: lower cushioning layer, 9: lower plate, 10: elastic plate, 11: optically transparent rigid substrate, 12: transfer-target substrate, 13: curable resin material, 14: ultraviolet ray, 15: substrate-loading position, 16: resin coating mechanism, 16-1: resin coating nozzle, 16-2: spindle chuck, 17: substrate-handling mechanism, 17-1: vertical handling arm, 17-2: chuck head, 17-3: horizontal handling arm, 18: aligning mechanism, 19: pressurizing mechanism, 19-1: upper head, 19-2: lower stage, 19-3: stamper, 19-4: ultraviolet ray irradiation mechanism, 19-5, 19-6: cushioning layer, 19-7: support arms, 20: separating mechanism, 20-1: separating chuck, 20-2, 60: O-ring, 20-3: suction cavities, 21: microscopic structure transfer mechanism, 31: lower stamper device, 32: upper stamper device, 33: transfer target separating device, 34: movable table, 35: seating, 36: guide rail, 37: movement-driving mechanism, 38: elevating mechanism, 39: control unit, 40: XY stage, 41: alignment camera, 42: ultraviolet source, 43: stamper-carrying stage, 44: lower stamper, 45a, 45b, 49a, 49b: stamper clamps, 46: stamper-support table, 47: upper stamper, 48: ultraviolet source, 50a, 50b: stopper, 51: disk, 52: disk substrate-handling arm, 53: disk substrate chuck, 54: curable resin material, 55: curable-resin-non-coated region, 56: transferred disk, 57: disk support shaft, 58: vacuum chuck unit, 59: evacuation port, 61: unloader, 62: silica beads, 63: non-contact length, 64: silica bead height, 65: glass substrate, 66: resin composition hardener for stamper, 67: droplet curable resin, 68: release direction, 69: gap-forming tape, 105: transfer target.

What is claimed is:

1. A transfer apparatus of a microscopic structure, the transfer apparatus comprising:
a stamper including a base and a microscopic structure layer formed on a surface of the base; and
a pressurizing mechanism including an upper head and a lower stage between which a transfer-target substrate and the stamper are sandwiched and pressurized, the transfer-target substrate having a resin coating thereon, and
the transfer apparatus curing the resin while pressing the microscopic structure layer against the resin and thereby forms a microscopic structural body of the resin on the surface of the transfer-target substrate,
wherein the microscopic structure layer has a surface layer including a polymer derived from a resin composition containing a silsesquioxane derivative.

2. The transfer apparatus according to claim 1, further comprising:
a resin coating mechanism;
a substrate-handling mechanism;
an aligning mechanism; and
a separating mechanism,
wherein the stamper is fixable to a bottom of the upper head,
the lower stage and the separating mechanism are horizontally movable,
the lower stage horizontally moves after being separated from the transfer-target substrate which is in intimate contact with the stamper, and
the separating mechanism moves to a lower part of the transfer-target substrate in intimate contact with the stamper and peels off the transfer-target substrate from the stamper.

3. The transfer apparatus according to claim 2, further comprising:
a guide rail; and
a movement-driving mechanism,
wherein the lower stage and the separating mechanism are installed on the guide rail so as to be movable along the guide rail, and
the movement-driving mechanism allows the lower stage and the separating mechanism to be movable alternately to such a position as to face the stamper with a center on a position of the stamper supported by the upper head.

4. The transfer apparatus according to claim 1, wherein the microscopic structure layer has a modulus of elasticity of less than 2.0 GPa and has a thickness of 4 times or more the height of a microscopic structure formed on the surface of the microscopic structure layer.

5. The transfer apparatus according to claim 1, wherein the microscopic structure layer has a modulus of elasticity of more than 0.3 GPa.

6. The transfer apparatus according to claim 1, wherein the resin composition contains a polymerization initiator which is a cationic-polymerization initiator which generates a cation by an action of an ultraviolet ray and thereby initiates curing.

7. The transfer apparatus according to claim 1, wherein the resin composition comprises a monomer component having at least two polymerizable functional groups.

8. The transfer apparatus according to claim 1, wherein the resin composition comprises two or more different monomer components, and at least one of the monomer components has a perfluoro skeleton.

9. A transfer apparatus of a double-sided microscopic structure, the transfer apparatus comprising:
an upper stamper and a lower stamper each including a base and a microscopic structure layer formed on a surface of the base;
an elevating mechanism;
a guide rail;
a movement-driving mechanism; and
a separating mechanism,
the upper stamper being supported by the elevating mechanism so as to be vertically movable,
the lower stamper being fixed to a movable table installed on the guide rail,
the separating mechanism being arranged on the guide rail,
the movable table and the separating mechanism being horizontally movable along the guide rail,
the movement-driving mechanism allowing the lower stage and the separating mechanism to be movable alternately to such a position as to face the upper stamper with a center on a position of the upper stamper, and
the transfer apparatus curing the resin while pressing the microscopic structure layers of the upper stamper and the lower stamper against the resin and thereby forms microscopic structural bodies of the resin on both sides of the transfer-target substrate,
wherein the microscopic structure layers each have a surface layer including a polymer derived from a resin composition containing a silsesquioxane derivative.

10. The transfer apparatus according to claim 9, wherein the microscopic structure layers each have a modulus of elasticity of less than 2.0 GPa and each have a thickness of 4 times or more the height of a microscopic structure formed on a surface of the microscopic structure layer.

11. The transfer apparatus according to claim 9, wherein the microscopic structure layers each have a modulus of elasticity of more than 0.3 GPa.

12. The transfer apparatus according to claim 9, wherein the resin composition comprises a polymerization initiator which is a cationic-polymerization initiator which generates a cation by an action of an ultraviolet ray and thereby initiates curing.

13. The transfer apparatus according to claim 9, wherein the resin composition comprises a monomer component having at least two polymerizable functional groups.

14. A stamper for the transfer of a microscopic structure, the stamper comprising:
a base; and
a microscopic structure layer formed on a surface of the base,
wherein the microscopic structure layer has a surface layer including a polymer which is derived from a resin composition containing a polymerization initiator and a silsesquioxane derivative having a plurality of polymerizable functional groups, and
the microscopic structure layer has a modulus of elasticity of less than 2.0 GPa and has a thickness of 4 times or more the height of a microscopic structure formed on a surface of the microscopic structure layer.

15. The stamper according to claim 14, wherein the microscopic structure layer has a modulus of elasticity of more than 0.3 GPa.

16. The stamper according to claim 14, wherein the polymerization initiator is a cationic-polymerization initiator which generates a cation by an action of an ultraviolet ray and thereby initiates curing.

17. The stamper according to claim 14, wherein the resin composition comprises a monomer component having at least two polymerizable functional groups.

18. The stamper according to claim 14,
wherein the resin composition comprises two or more different monomer components,
at least one of the monomer components has a perfluoro skeleton, and
at least one of the monomer components has at least two polymerizable functional groups.

19. The stamper according to claim 18, wherein one of the monomer components is 1,4-bis(2,3-epoxypropyl)perfluorobutane.

20. The stamper according to claim 14, further comprising an optically transparent elastic plate and an optically transparent rigid substrate on an opposite surface to a surface having the microscopic structure layer of the base.
